(19) United States
(12) Patent Application Publication
(10) Pub. No.: US 2020/0325362 A1
(43) Pub. Date: Oct. 15, 2020

(54) PRESSURE-SENSITIVE ADHESIVE STRIP

(71) Applicant: TESA SE, Norderstedt (DE)

(72) Inventors: Axel BURMEISTER, Hamburg (DE); Mathias HOSER, Hamburg (DE); Franciska LOHMANN, Hamburg (DE)

(21) Appl. No.: 16/305,775

(22) PCT Filed: Feb. 16, 2017
(86) PCT No.: PCT/EP2017/053553

§ 371 Date: Nov. 29, 2018

(30) Foreign Application Priority Data
Jun. 2, 2016 (DE) 10 2016 209 707.5

(51) Int. Cl. C09J 7/38; C09J 7/24; C09J 7/25; C08J 9/32; C08J 7/18; C08J 7/04; C08K 5/00

(52) U.S. Cl. CPC C09J 7/385; C08F 220/1808; C09J 7/243; C09J 7/255; C08J 9/32; C08J 7/18; C08J 7/04; C08K 5/0025; C09J 2201/128; C09J 2201/606; C09J 2205/11; C09J 2400/24; C09J 2423/106; C09J 2467/006; C09J 2477/006; C09J 2479/086; C09J 2203/326; C09J 7/383

(57) ABSTRACT

The invention relates to a pressure-sensitive adhesive strip composed of three layers, comprising
an inner layer F composed of a nonextensible film carrier,
a layer SK1 composed of a self-adhesive composition arranged on one of the surfaces of the film carrier layer F and based on a foamed acrylate composition,
a layer SK2 composed of a self-adhesive composition arranged on the opposite surface of the film carrier layer F from layer SK1 and based on a foamed acrylate composition.

The invention relates to a pressure-sensitive adhesive (PSA) strip.

Adhesive tapes are frequently used for the bonding of ultrasmall components, for example in devices in the consumer electronics industry. In order to enable this, it is necessary for the form of the adhesive tape section to be matched to the form of the component. In this case, difficult geometries are often also necessary, which are obtained by die-cutting of the adhesive tape. Thus, element widths in die-cut parts of a few millimeters are by no means rare. On application of these sensitive adhesive tapes to the components, there is frequently deformation of the die-cut parts.

In order to suppress or at least reduce the deformation, it has been found to be advantageous to integrate a film, for example a PET film, into the adhesive tapes as a middle lamina in order to absorb the tensile forces on application.

Bonds with such adhesive tapes are increasingly also being used if the component is subject to shocks. Particularly shock-resistant bonds have been found to be those with pressure-sensitive adhesive strips having a viscoelastic, syntactically foamed core, a stabilizing film and, on the outer laminas, two self-adhesive bonding layers.

These pressure-sensitive adhesive strips are capable of such high performance that cohesive fracture within the pressure-sensitive adhesive strip is to be observed under shock. The bond between the foamed core and the stabilizing film fails, and foam and film are parted from one another.

Foamed pressure-sensitive adhesive composition systems have long been known and are described in the prior art.

In principle, polymer foams can be produced in two ways. One way is via the effect of a blowing gas, whether added as such or resulting from a chemical reaction, and a second way is via incorporation of hollow beads into the material matrix. Foams that have been produced by the latter route are referred to as syntactic foams.

In the case of a syntactic foam, hollow beads such as glass beads or hollow ceramic beads (microbeads) or microballoons are incorporated in a polymer matrix. As a result, in a syntactic foam, the voids are separated from one another and the substances (gas, air) present in the voids are divided from the surrounding matrix by a membrane.

Compositions foamed with hollow microbeads are notable for a defined cell structure with a homogeneous size distribution of the foam cells. With hollow microbeads, closed-cell foams without voids are obtained, the features of which include better sealing action against dust and liquid media compared to open-cell variants. Furthermore, chemically or physically foamed materials have a greater propensity to irreversible collapse under pressure and temperature, and frequently show lower cohesive strength.

Particularly advantageous properties can be achieved when the microbeads used for foaming are expandable microbeads (also referred to as “microballoons”). By virtue of their flexible, thermoplastic polymer shell, foams of this kind have higher adaptation capacity than those filled with non-expandable, non-polymeric hollow microbeads (for example hollow glass beads). They have better suitability for compensation for manufacturing tolerances, as is the rule, for example, in the case of injection-molded parts, and can also better compensate for thermal stresses because of their foam character.

Furthermore, it is possible to further influence the mechanical properties of the foam via the selection of the thermoplastic resin of the polymer shell. For example, even when the foam has a lower density than the matrix, it is possible to produce foams having higher cohesive strength than with the polymer matrix alone. For instance, typical foam properties such as adaptation capacity to rough substrates can be combined with a high cohesive strength for self-adhesive foams.

Among the devices in the consumer electronics industry are electronic, optical and precision devices, in the context of this application especially those devices as classified in Class 9 of the International Classification of Goods and Services for the Registration of Marks (Nice classification); 10th edition (NCL(10-2013)), to the extent that these are electronic, optical or precision devices, and also clocks and time-measuring devices according to Class 14 (NCL(10-2013)),

such as, in particular,
scientific, marine, surveying, photographic, film, optical, weighing, measuring, signalling, monitoring, rescuing, and instruction apparatus and instruments;
apparatus and instruments for conducting, switching, converting, storing, regulating and monitoring electricity;
image recording, processing, transmission, and reproduction devices, such as televisions and the like;
acoustic recording, processing, transmission, and reproduction devices, such as broadcasting devices and the like;
computers, calculating instruments and data-processing devices, mathematical devices and instruments, computer accessories, office instruments—for example, printers, faxes, copiers, typewriters—, data-storage devices;
telecommunications devices and multifunction devices with a telecommunications function, such as telephones and answering machines;
chemical and physical measuring devices, control devices, and instruments, such as battery chargers, multimeters, lamps, and tachometers;
nautical devices and instruments;
optical devices and instruments;
medical devices and instruments and those for sportspeople;
clocks and chronometers;
solar cell modules, such as electrochemical dye solar cells, organic solar cells, and thin-film cells;
fire-extinguishing equipment.

Technical development is going increasingly in the direction of devices which are ever smaller and lighter in design, allowing them to be carried at all times by their owner, and usually being generally carried. This is accomplished increasingly nowadays by realization of low weights and/or suitable size of such devices. Such devices are also referred to as mobile devices or portable devices for the purposes of this specification. In this development trend, precision and optical devices are increasingly being provided (also) with electronic components, thereby raising the possibilities for minimization. On account of the carrying of the mobile devices, they are subject to increased loads—in particular, to mechanical loads—as for instance by impact on edges, by being dropped, by contact with other hard objects in a bag, or else simply by the permanent motion involved in being carried per se. Mobile devices, however, are also subject to a greater extent to loads due to moisture exposure, temperature influences, and the like, than those “immobile” devices which are usually installed in interiors and which move little or not at all.

The invention accordingly refers with particular preference to mobile devices, since the pressure-sensitive adhesive strip used in accordance with the invention has a particular benefit here on account of their unexpectedly good properties (very high shock resistance). Listed below are a number of portable devices, without wishing the representatives specifically identified in this list to impose any unnecessary restriction with regard to the subject matter of the invention.
cameras, digital cameras, photography accessories (such as light meters, flashguns, diaphragms, camera casings, lenses, etc.), film cameras, video cameras
small computers (mobile computers, handheld computers, handheld calculators), laptops, notebooks, netbooks, ultrabooks, tablet computers, handhelds, electronic diaries and organizers (called “electronic organizers” or “personal digital assistants”, PDAs, palmtops), modems,
computer accessories and operating units for electronic devices, such as mice, drawing pads, graphics tablets, microphones, loudspeakers, games consoles, gamepads, remote controls, remote operating devices, touchpads
monitors, displays, screens, touch-sensitive screens (sensor screens, touchscreen devices), projectors
reading devices for electronic books (“E-books”)
mini TVs, pocket TVs, devices for playing films, video players
radios (including mini and pocket radios), Walkmans, Discmans, music players for e.g. CDs, DVDs, Blu-ray, cassettes, USB, MP3, headphones
cordless telephones, cellphones, smartphones, two-way radios, hands-free telephones, devices for summoning people (pagers, bleepers)
mobile defibrillators, blood sugar meters, blood pressure monitors, step counters, pulse meters
torches, laser pointers
mobile detectors, optical magnifiers, binoculars, night vision devices
GPS devices, navigation devices, portable interface devices for satellite communications
data storage devices (USB sticks, external hard drives, memory cards)
wristwatches, digital watches, pocket watches, chain watches, stopwatches.

For these devices, a particular requirement is for adhesive tapes having high holding performance.

In addition, it is important that the holding performance of the adhesive tapes does not fail when the electronic device, for example a cellphone, is dropped and hits the ground. The adhesive strip must thus have very high shock resistance.

DE 10 2016 202 479, a patent application from the same applicant as this document that was still unpublished at the priority date of the present application, describes a four-layer adhesive tape in which a foamed inner layer is additionally strengthened by a PET stabilization film. By virtue of such a construction, it was possible to offer particularly shock-resistant adhesive tapes.

It is an object of the invention with respect to the published prior art to find a pressure-sensitive adhesive strip that has particularly high shock resistance particularly in the z plane (i.e., in particular, perpendicularly to the bonding plane with respect to mechanical action). Moreover, it was desirable, based on the subject matter described in document DE 10 2016 202 479, to be able to provide a more favorable and simpler adhesive tape construction without having to accept any great losses in the positive properties of shock resistance.

The object is achieved in accordance with the invention by a pressure-sensitive adhesive strip of the generic type as set out in the main claim. The subject matter of the dependent claims comprises advantageous developments of the pressure-sensitive adhesive strip.

Accordingly, the invention relates to a pressure-sensitive adhesive strip composed of exactly three layers, comprising
an inner layer F composed of a film carrier,
a layer SK1 composed of a self-adhesive composition which is arranged on the top side of layer B and is based on a foamed self-adhesive acrylate composition,
a layer SK2 composed of a self-adhesive composition which is arranged on the opposite side of layer F from layer SK1 and is likewise based on a foamed self-adhesive acrylate composition.

The film carrier is preferably nonextensible.

The inner layer F composed of a film carrier is also referred to synonymously in the context of this document simply as film carrier, film layer or film carrier layer.

The layers SK1 and SK2 of self-adhesive composition, in the context of this document, are also referred to as self-adhesive composition layers SK1 and SK2, simply as layers SK1 and SK2, or else as outer layers, adhesive composition layers, self-adhesive composition layers or pressure-sensitive adhesive composition layers SK1 and SK2. The term “outer” relates here to the three-layer construction of the pressure-sensitive adhesive strip, regardless of any liner present on the outer faces of the self-adhesive composition layers (see further down).

In an advantageous procedure, one or both surfaces of the film layer F have been physically and/or chemically pretreated. Such a pretreatment can be effected, for example, by etching and/or corona treatment and/or plasma pretreatment and/or primer treatment. If both surfaces of the film layer have been pretreated, the pretreatment of each surface may have been different or, more particularly, both surfaces may have been given the same pretreatment.

A particularly preferred embodiment of the invention concerns a pressure-sensitive adhesive strip of symmetric construction in relation to the composition of the layers, in that the foamed self-adhesive acrylate compositions of the two outer layers SK1 and SK2 are chemically identical, and advantageously also, if additives are added thereto, these are identical and used in an identical amount.

Also achievable in accordance with the invention is a pressure-sensitive adhesive strip which is of structurally symmetric construction in z direction, but in which the outer self-adhesive composition layers SK1 and SK2 are of equal thickness and/or have the same density but—as respectively foamed self-adhesive acrylate composition layers—are chemically different.

In a very advantageous procedure, the pressure-sensitive adhesive strip is of entirely symmetric construction, i.e. both with regard to the chemical composition of the two foamed self-adhesive acrylate composition layers SK1 and SK2 (including any additizations present therein) and with regard to the structural composition thereof, in that both surfaces of the especially nonextensible film carrier F have been identically pretreated and the two outer self-adhesive composition layers SK1 and SK2 have the same thickness and density. “Entirely symmetric” relates especially to the z direction (“thickness”, direction perpendicular to the plane of the pressure-sensitive adhesive strip) of the pressure-sensitive adhesive strip, but may of course additionally also relate to the geometry in the surface plane (x and y directions, i.e. length and width, of the pressure-sensitive adhesive strip).

The remarks which follow relate explicitly and without exception also to the entirely symmetric embodiment of the invention.

The self-adhesive acrylate compositions of layers SK1 and SK2 are each a pressure-sensitive adhesive (PSA) composition. The terms “self-adhesive” and “pressure-sensitively adhesive” are used synonymously in this respect within the scope of this document.

Pressure-sensitive adhesive compositions are especially those polymeric compositions which—if appropriate by suitable additization with further components, for example tackifying resins—are permanently tacky and adhesive at the use temperature (unless defined otherwise, at room temperature) and adhere on contact to a multitude of surfaces, and especially adhere immediately (have so-called “tack” [tackiness or touch-tackiness]). They are capable, even at the use temperature, without activation by solvent or by heat—but typically via the influence of a greater or lesser pressure—of sufficiently wetting a substrate to be bonded such that sufficient interactions for adhesion can form between the composition and the substrate. Influencing parameters that are essential in this respect include the pressure and the contact time. The exceptional properties of the pressure-sensitive adhesive compositions derive, inter alia, especially from their viscoelastic properties. For example, it is possible to produce weakly or strongly adhering adhesive compositions; and also those that can be bonded just once and permanently, such that the bond cannot be parted without destruction of the adhesive and/or the substrates, or those that can readily be parted again and, if appropriate, bonded repeatedly.

Pressure-sensitive adhesive compositions can in principle be produced on the basis of polymers of different chemical nature. The pressure-sensitive adhesive properties are affected by factors including the nature and the ratios of the monomers used in the polymerization of the polymers underlying the pressure-sensitive adhesive composition, the average molar mass and molar mass distribution thereof, and the nature and amount of the additives to the pressure-sensitive adhesive composition, such as tackifying resins, plasticizers and the like.

To achieve the viscoelastic properties, the monomers on which the polymers underlying the pressure-sensitive adhesive composition are based, and any further components present in the pressure-sensitive adhesive composition, are especially chosen such that the pressure-sensitive adhesive composition has a glass transition temperature (to DIN 53765) below the use temperature (i.e. typically below room temperature).

By means of suitable cohesion-enhancing measures, for example crosslinking reactions (formation of bridge-forming linkages between the macromolecules), it is possible to enlarge and/or to shift the temperature range in which a polymer composition has pressure-sensitive adhesive properties. The range of application of the pressure-sensitive adhesive compositions can thus be optimized via a setting between flowability and cohesion of the composition.

A pressure-sensitive adhesive composition has permanent pressure-sensitive adhesion at room temperature, i.e. has a sufficiently low viscosity and high touch-tackiness, such that it wets the surface of the respective adhesive substrate even at low contact pressure. The bondability of the adhesive composition is based on its adhesive properties, and the redetachability is based on its cohesive properties.

Adhesive Compositions Usable in Accordance with the Invention

Compositions usable in the context of the invention for the self-adhesive compositions SK1 and SK2 are solvent-based acrylate-based adhesive compositions, on an aqueous basis or else in the form of a hotmelt system, for example an acrylate hotmelt-based composition, where the latter may have a K value of at least 20, especially greater than 30, obtainable by concentration of a solution of such a composition to a system processible as a hotmelt. The concentration can take place in appropriately equipped tanks or extruders; preference is given to a vented extruder in the case of associated degassing.

An adhesive composition of this kind is set out in DE 43 13 008 A1, the contents of which are hereby referenced and incorporated into this disclosure and invention.

The acrylate hotmelt-based adhesive composition may have been chemically crosslinked.

An adhesive composition which is likewise found to be suitable is a low molecular weight hotmelt acrylate adhesive composition, for example acResin® UV from BASF, and acrylate dispersion pressure-sensitive adhesive compositions as obtainable, for example, under the Acronal® trade name from BASF.

In a further embodiment, the self-adhesive compositions used are copolymers of (meth)acrylic acid and esters thereof having 1 to 25 carbon atoms, maleic acid, fumaric acid and/or itaconic acid and/or esters thereof, substituted (meth)acrylamides, maleic anhydride and other vinyl compounds such as vinyl esters, especially vinyl acetate, vinyl alcohols and/or vinyl ethers.

The residual solvent content should be below 1% by weight.

Another preferred embodiment is a pressure-sensitive adhesive composition comprising a polyacrylate polymer. This is a polymer obtainable by free-radical polymerization of acrylic monomers, which are also understood to mean methacrylic monomers, and optionally further copolymerizable monomers.

According to the invention, it may be a polyacrylate crosslinkable with epoxy groups. Accordingly, monomers or comonomers used may preferably be functional monomers crosslinkable with epoxy groups; monomers employed here especially include monomers having acid groups (particularly carboxylic acid, sulfonic acid or phosphoric acid groups) and/or hydroxyl groups and/or acid anhydride groups and/or epoxy groups and/or amine groups; preference is given to monomers containing carboxylic acid groups. It is especially advantageous when the polyacrylate includes polymerized acrylic acid and/or methacrylic acid.

Further monomers which can be used as comonomers for the polyacrylate are, for example, acrylic and/or methacrylic esters having up to 30 carbon atoms, vinyl esters of carboxylic acids having up to 20 carbon atoms, vinylaromatics having up to 20 carbon atoms, ethylenically unsaturated nitriles, vinyl halides, vinyl ethers of alcohols containing 1 to 10 carbon atoms, aliphatic hydrocarbons having 2 to 8 carbon atoms and 1 or 2 double bonds, or mixtures of these monomers.

Preference is given to using a polyacrylate which can be derived from the following monomer composition:
i) acrylic esters and/or methacrylic esters of the following formula

CH₂=C(R¹)(COOR²)
where R¹=H or CH₃ and R²=H or linear, branched or cyclic, saturated or unsaturated alkyl radicals having 1 to 30 and especially having 4 to 18 carbon atoms,
ii) olefinically unsaturated monomers having functional groups of the type already defined for reactivity with epoxy groups,
iii) optionally further acrylates and/or methacrylates and/or olefinically unsaturated monomers copolymerizable with component (i).

Further preferably, for use of the polyacrylate as pressure-sensitive adhesive, the proportions of the corresponding components (i), (ii) and (iii) are chosen such that the polymerization product especially has a glass transition temperature of not more than 15° C. (determined by DSC (differential scanning calorimetry) according to DIN 53 765 at a heating rate of 10 K/min).

It is very advantageous for production of the pressure-sensitive adhesive compositions that the monomers of component (i) be chosen with a proportion of 45% to 95% by weight, the monomers of component (ii) with a proportion of 1% to 15% by weight and the monomers of component (iii) with a proportion of 0% to 40% by weight (the figures are based on the monomer mixture for the “base polymer”, i.e. without additions of any additives to the finished polymer, such as resins).

The monomers of component (i) are especially plasticizing and/or nonpolar monomers. Preference is given to using, for the monomers (i), acrylic monomers comprising acrylic and methacrylic esters having alkyl groups consisting of 4 to 18 carbon atoms, preferably 4 to 9 carbon atoms. Examples of such monomers are n-butyl acrylate, n-butyl methacrylate, n-pentyl acrylate, n-pentyl methacrylate, n-amyl acrylate, n-hexyl acrylate, hexyl methacrylate, n-heptyl acrylate, n-octyl acrylate, n-octyl methacrylate, n-nonyl acrylate, isobutyl acrylate, isooctyl acrylate, isooctyl methacrylate and the branched isomers thereof, for example 2-ethylhexyl acrylate or 2-ethylhexyl methacrylate.

Preference is given to using, for component (ii), monomers having those functional groups selected from the following enumeration:

hydroxyl, carboxyl, sulfo or phosphonic acid groups, acid anhydrides, epoxides, amines.

Particularly preferred examples of monomers of component (ii) are acrylic acid, methacrylic acid, itaconic acid, maleic acid, fumaric acid, crotonic acid, aconitic acid, dimethylacrylic acid, p-acryloyloxypropionic acid, trichloroacrylic acid, vinylacetic acid, vinylphosphonic acid, itaconic acid, maleic anhydride, hydroxyethyl acrylate, hydroxypropyl acrylate, hydroxyethyl methacrylate, hydroxypropyl methacrylate, 6-hydroxyhexyl methacrylate, allyl alcohol, glycidyl acrylate, glycidyl methacrylate.

Monomers mentioned by way of example for component (iii) are: methyl acrylate, ethyl acrylate, propyl acrylate, methyl methacrylate, ethyl methacrylate, benzyl acrylate, benzyl methacrylate, sec-butyl acrylate, tert-butyl acrylate, phenyl acrylate, phenyl methacrylate, isobornyl acrylate, isobornyl methacrylate, t-butylphenyl acrylate, t-butylphenyl methacrylate, dodecyl methacrylate, isodecyl acrylate, lauryl acrylate, n-undecyl acrylate, stearyl acrylate, tridecyl acrylate, behenyl acrylate, cyclohexyl methacrylate, cyclopentyl methacrylate, phenoxyethyl acrylate, phenoxyethyl methacrylate, 2-butoxyethyl methacrylate, 2-butoxyethyl acrylate, 3,3,5-trimethylcyclohexyl acrylate, 3,5-dimethyladamantyl acrylate, 4-cumylphenyl methacrylate, cyanoethyl acrylate, cyanoethyl methacrylate, 4-biphenyl acrylate, 4-biphenyl methacrylate, 2-naphthyl acrylate, 2-naphthyl methacrylate, tetrahydrofufuryl acrylate, diethylaminoethyl acrylate, diethylaminoethyl methacrylate, dimethylaminoethyl acrylate, dimethylaminoethyl methacrylate, 2-butoxyethyl acrylate, 2-butoxyethyl methacrylate, methyl 3-methoxyacrylate, 3-methoxybutyl acrylate, phenoxyethyl acrylate, phenoxyethyl methacrylate, 2-phenoxyethyl methacrylate, butyldiglycol methacrylate, ethylene glycol acrylate, ethylene glycol monomethyl acrylate, methoxy polyethylene glycol methacrylate 350, methoxy polyethylene glycol methacrylate 500, propylene glycol monomethacrylate, butoxy diethylene glycol methacrylate, ethoxy triethyleneglycol methacrylate, octafluoropentyl acrylate, octafluoropentyl methacrylate, 2,2,2-trifluoroethyl methacrylate, 1,1,1,3,3,3-hexafluoroisopropyl acrylate, 1,1,1,3,3,3-hexafluoroisopropyl methacrylate, 2,2,3,3,3-pentafluoropropyl methacrylate, 2,2,3,4,4,4-hexafluorobutyl methacrylate, 2,2,3,3,4,4,4-heptafluorobutyl acrylate, 2,2,3,3,4,4,4-heptafluorobutyl methacrylate, 2,2,3,3,4,4,5,5,6,6,7,7,8,8,8-pentadecafluorooctyl methacrylate, dimethylaminopropylacrylamide, dimethylaminopropylmethacrylamide, N-(1-methylundecyl)acrylamide, N-(n-butoxymethyl)acrylamide, N-(butoxymethyl)methacrylamide, N-(ethoxymethyl)acrylamide, N-(n-octadecyl)acrylamide, and also N,N-dialkyl-substituted amides, for example N,N-dimethylacrylamide, N,N-dimethylmethacrylamide, N-benzylacrylamides, N-isopropylacrylamide, N-tert-butylacrylamide, N-tert-octylacrylamide, N-methylolacrylamide, N-methylolmethacrylamide, acrylonitrile, methacrylonitrile, vinyl ethers such as vinyl methyl ether, ethyl vinyl ether, vinyl isobutyl ether, vinyl esters such as vinyl acetate, vinyl chloride, vinyl halides, vinylidene chloride, vinylidene halides, vinylpyridine, 4-vinylpyridine, N-vinylphthalimide, N-vinyllactam, N-vinylpyrrolidone, styrene, a- and p-methylstyrene, a-butylstyrene, 4-n-butylstyrene, 4-n-decylstyrene, 3,4-dimethoxystyrene. Macromonomers such as 2-polystyrene-ethyl methacrylate (molecular weight M_{w} from 4000 to 13 000 g/mol), poly(methyl methacrylate)-ethyl methacrylate (M_{w} from 2000 to 8000 g/mol).

Monomers of component (iii) may advantageously also be chosen such that they contain functional groups that assist subsequent radiation-chemical crosslinking (for example by electron beams, UV). Suitable copolymerizable photoinitiators are, for example, benzoin acrylate and acrylate-functionalized benzophenone derivatives. Monomers that assist crosslinking by electron bombardment are, for example tetrahydrofurfuryl acrylate, N-tert-butylacrylamide, allyl acrylate, but this enumeration is not conclusive.

A further article of the composition of the pressure-sensitive adhesive is epoxy-based crosslinkers. Substances containing epoxy groups that are used are especially polyfunctional epoxides, i.e. those that have at least two epoxy units per molecule (i.e. are at least bifunctional). These may be either aromatic or aliphatic compounds. Epoxy-based crosslinkers may also be used in oligomeric or polymeric form.

The mixture of acrylates may in turn further preferably have the following composition:
(I) 90% to 99% by weight of n-butyl acrylate and/or 2-ethylhexyl acrylate
(II) 1% to 10% by weight of an ethylenically unsaturated monomer having an acid or acid anhydride function

where (I) and (II) preferably add up to 100% by weight.

Preferably, the monomer (I) is composed of a mixture of 2-ethylhexyl acrylate and n-butyl acrylate, further preferably in equal parts.

Useful monomers (II) advantageously include acrylic acid, methacrylic acid, itaconic acid, maleic acid, fumaric acid and/or maleic anhydride.

Preference is given to acrylic acid or methacrylic acid, optionally the mixture of the two.

For achievement of pressure-sensitive adhesive properties, the adhesive composition should preferably be above its glass transition temperature at the processing temperature in order to have viscoelastic properties. The glass transition temperature of the pressure-sensitive adhesive composition formulation (polymer-tackifier mixture) is therefore preferably below +15° C. (determined by DSC (differential scanning calorimetry) according to DIN 53 765 at a heating rate of 10 K/min).

The glass transition temperature of the acrylate copolymers can be estimated according to the Fox equation from the glass transition temperatures of the homopolymers and their relative ratios.

To achieve polymers, for example pressure-sensitive adhesive compositions or heat-sealing compositions, having desired glass transition temperatures, the quantitative composition of the monomer mixture is advantageously chosen so as to give the desired T_{G} for the polymer according to an equation (G1) in analogy to the Fox equation (cf. T. G. Fox, Bull. Am. Phys. Soc. 1956, 1, 123).

$$\frac{1}{{T}_{G}} = {\sum }_{n} \frac{{w}_{n}}{{T}_{G , n}} \qquad ( G 1 )$$

n=serial number over the monomers used,

wₙ=proportion by mass of the respective monomer n (% by weight) and

T_{G,n}=respective glass transition temperature of the homopolymer formed from the respective monomers n in K.

Analogously, equation G1 can also be employed for determination and prediction of the glass transition temperature of polymer mixtures. In that case, if the mixtures are homogeneous mixtures,

n=serial number over the polymers used,

wₙ=proportion by mass of the respective polymer n (% by weight) and

T_{G,n}=respective glass transition temperature of the polymer n in K.

The possible addition of tackifiers inevitably increases the glass transition temperature, by about 5 to 40 K according to the amount added, compatibility and softening temperature. Preference is therefore given to acrylate copolymers having a glass transition temperature of not more than 0° C.

In a further advantageous execution of the invention, the adhesive composition has been admixed with a second, elastomer-based polymer component essentially immiscible with the polyacrylate component (called elastomer component hereinafter), especially one or more synthetic rubbers.

Preferably, the adhesive composition in that case comprises at least the following two components:
(P) a first, polyacrylate-based polymer component,
(E) a second, elastomer-based polymer component essentially immiscible with the polyacrylate component, especially a synthetic rubber (called “elastomer component” hereinafter).

The polyacrylate component P is present more particularly to an extent of 60% by weight to 90% by weight, preferably 65% by weight to 80% by weight, and the elastomer component (E) lies especially to an extent of 10% by weight to 40% by weight, preferably 15% by weight to 30% by weight, based on the sum total of polyacrylate component (P) and elastomer component (E) as 100% by weight. The overall composition of the adhesive composition may especially be restricted to these two components, but it is also possible for there to be further, additional components such as additives and the like (in this regard see also further down).

According to the invention, the second polymer component (elastomer component (E)) is essentially immiscible with the first polymer component (polymer component (P)), and so the adhesive composition in the adhesive composition layer is present in at least two separate phases. More particularly, one phase forms a matrix and the other phase a multitude of domains arranged within the matrix.

Homogeneous mixtures are substances mixed at the molecular level; homogeneous systems are accordingly monophasic systems. The underlying substances are referred to in a synonymous manner in the context of this document as mutually “homogeneously miscible” and “compatible”. Accordingly, two or more components are synonymously “not homogeneously miscible” and “incompatible” when they do not form a homogeneous system after intimate mixing, but at least two phases. Synonymously “partly homogeneously miscible” and “partly compatible” components are regarded as being those which form at least two phases on intimate mixing with one another (for example by shearing, in the melt or in solution and subsequently eliminating the solvent), each of which is rich in one of the components, but one or both of the phases may each include a greater or lesser portion of the other components in a homogeneous mixture.

The polyacrylate component (P) is preferably a homogeneous phase. The elastomer component (E) may be intrinsically homogeneous or itself have intrinsic polyphasicity, as known from microphase-separating block copolymers. In the present context, polyacrylate component and elastomer component are chosen such that—after intimate mixing—they are essentially immiscible at 23° C. (i.e. the customary use temperature for adhesive compositions). “Essentially immiscible” means that the components are either not homogeneously miscible with one another at all, such that none of the phases includes a proportion of the second component in a homogeneous mixture, or that the components are partly compatible with one another only to such a minor degree, i.e. one or both components can homogeneously absorb only such a small proportion of the respective other component, that the partial compatibility is not essential to the invention, i.e. is not detrimental to the teaching of the invention. In that case, the corresponding components are considered in the context of the present invention to be “essentially free” of the respective other component.

The adhesive composition used in accordance with the invention is accordingly present in at least biphasic morphology at least at room temperature (23° C.). Very preferably, the polyacrylate component (P) and the elastomer component (E) are essentially not homogeneously miscible within a temperature range from 0° C. to 50° C., even more preferably from −30° C. to 80° C.

Components in the context of this document are defined as being “essentially immiscible with one another” especially when the formation of at least two stable phases can be detected physically and/or chemically, where one phase is rich in one component—the polyacrylate component (P)—and the second phase is rich in the other component—the elastomer component (E). An example of a suitable analysis system for a phase separation is scanning electron microscopy. However, phase separation can also be recognized, for example, in that the different phases have two independent glass transition temperatures in dynamic differential calorimetry (DSC). Phase separation exists in accordance with the invention when it can be shown unambiguously by at least one of the analysis methods.

The phase separation may especially be implemented in that there are discrete regions (“domains”) that are rich in one component (formed essentially from one of the components and free of the other component) in a continuous matrix rich in the other component (essentially formed from the other component and free of the first component).

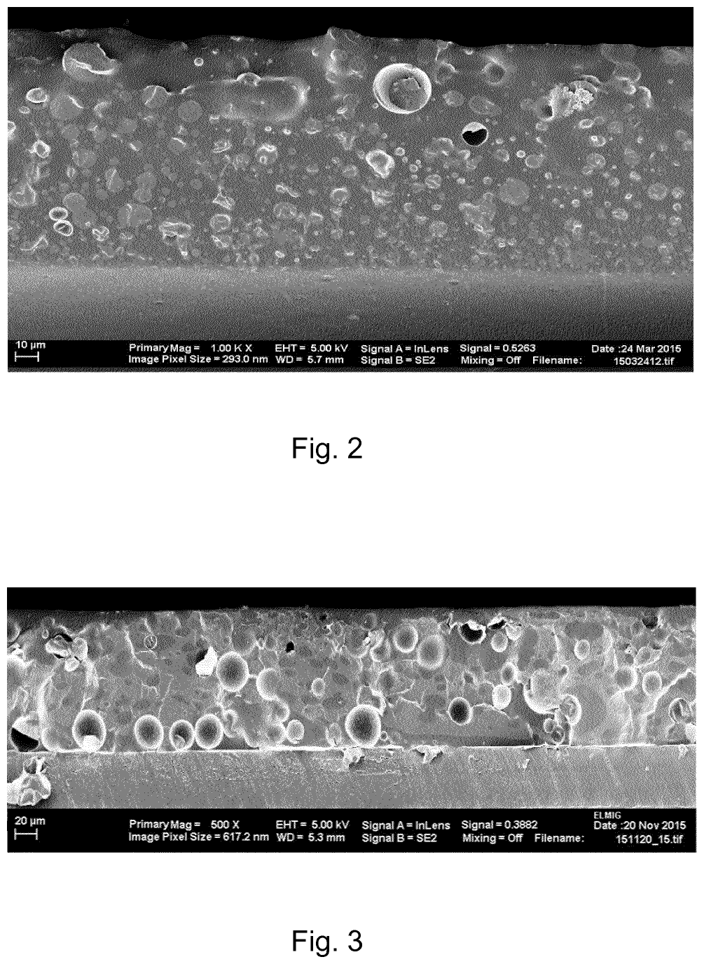

The phase separation for the adhesive compositions used in accordance with the invention especially takes place in that the elastomer component (E) is present in dispersed form in a continuous matrix of the polyacrylate component (P) (see FIG. 2). The regions (domains) formed by the elastomer component (E) are preferably in essentially spherical form. The regions (domains) formed by the elastomer component (E) may also depart from spherical form, and especially be distorted, for example elongated and oriented in coating direction. The size of the elastomer domains in their greatest dimension is typically—but not necessarily—between 0.5 μm and 150 μm, especially between 1 μm and 30 μm. Other domain forms are likewise possible, for example in the form of sheets or rods, where these may also depart from ideal structures in terms of their shape and may, for example, be bent or distorted.

The polyacrylate component (P) and the elastomer component (E) each consist of a base polymer component which may be a homopolymer, a copolymer or a mixture of polymers (homopolymers and/or copolymers), and optionally additions (co-components, additives).

In simplified form, the base polymer component is referred to hereinafter as “base polymer”, but this is not intended to exclude polymer mixtures for the respective base polymer component; correspondingly, “polyacrylate base polymer” is understood to mean the base polymer component of the polyacrylate component and “elastomer base polymer” to mean the base polymer component of the elastomer component of the adhesive composition.

The polyacrylate component (P) and/or the elastomer component (E) may each be in the form of 100% systems, i.e. based exclusively on their respective base polymer component and without further addition of resins, additives or the like. In a further preferred manner, one or both of these two components have been admixed not only with the base polymer component but also with further components, for example resins.

In an advantageous execution of the invention, the polyacrylate component (P) and the elastomer component (E) are composed exclusively of their respective base polymer components, and so no further polymeric components are present, and especially no resins are present. In a further development, the overall adhesive composition does not comprise any further constituents apart from the two base polymer components.

The polyacrylate-based adhesive composition or the polyacrylate component (P) has especially advantageously been admixed with one or more crosslinkers for chemical and/or physical crosslinking. However, since radiation-chemical crosslinking of the polyacrylate component (P) is also possible in principle, crosslinkers are not necessarily present.

Crosslinkers are those compounds—especially bi- or polyfunctional compounds, usually of low molecular weight—which can react under the crosslinking conditions chosen with suitable groups—especially functional groups—of the polymers to be crosslinked, thus join two or more polymers or polymer sites to one another (form “bridges”) and hence create a network of the polymer or polymers to be crosslinked. This generally results in an increase in cohesion. The degree of crosslinking depends on the number of bridges formed.

Crosslinkers in the present context are in principle all crosslinker systems that are known to the person skilled in the art for the formation particularly of covalent, coordinated or associative binding systems with appropriately modified (meth)acrylate monomers, according to the nature of the polymers chosen and their functional groups. Examples of chemical crosslinking systems are di- or polyfunctional isocyanates or di- or polyfunctional epoxides or di- or polyfunctional hydroxides or di- or polyfunctional amines or di- or polyfunctional acid anhydrides. Combinations of different crosslinkers are likewise conceivable.

Further suitable crosslinkers include chelate formers which, in combination with acid functionalities in polymer chains, form complexes that act as crosslinking points.

For effective crosslinking, it is especially advantageous when at least some of the polyacrylates have functional groups with which the respective crosslinkers can react. For this purpose, preference is given to using monomers having functional groups selected from the group comprising: hydroxyl, carboxyl, sulfo or phosphonic acid groups, acid anhydrides, epoxides, amines.

Particularly preferred examples of monomers for polyacrylates are acrylic acid, methacrylic acid, itaconic acid, maleic acid, fumaric acid, crotonic acid, aconitic acid, dimethylacrylic acid, p-acryloyloxypropionic acid, trichloroacrylic acid, vinylacetic acid, vinylphosphonic acid, maleic anhydride, hydroxyethyl acrylate, hydroxypropyl acrylate, hydroxyethyl methacrylate, hydroxypropyl methacrylate, 6-hydroxyhexyl methacrylate, allyl alcohol, glycidyl acrylate, glycidyl methacrylate.

It has been found to be particularly advantageous to use, as crosslinker, 0.03 to 0.2 part by weight, especially 0.04 to 0.15 part by weight, of N,N,N′,N′-tetrakis(2,3-epoxypropyl)-m-xylene-a,a′-diamine (tetraglycidyl-meta-xylenediamine; CAS 63738-22-7), based on 100 parts by weight of polyacrylate base polymer.

Alternatively or additionally, it may be advantageous to crosslink the adhesive composition by radiation-chemical means. Useful radiation for this purpose includes ultraviolet light (particularly when suitable photoinitiators have been added to the formulation or at least one polymer in the acrylate component contains comonomers having units of photoinitiating functionality) and/or electron beams.

It may be advantageous for radiation-induced crosslinking when some of the monomers used contain functional groups which assist subsequent radiation-chemical crosslinking. Suitable copolymerizable photoinitiators are, for example, benzoin acrylate and acrylate-functionalized benzophenone derivatives. Monomers that assist crosslinking by electron bombardment are, for example, tetrahydrofurfuryl acrylate, N-tert-butylacrylamide and allyl acrylate.

For chemical and/or physical and/or radiation-induced crosslinking, reference is made particularly to the relevant prior art.

For achievement of desired properties of the pressure-sensitive adhesive composition, for example in order to achieve sufficient cohesion of the pressure-sensitive adhesive compositions, the pressure-sensitive adhesive compositions are generally crosslinked, meaning that the individual macromolecules are joined to one another by bridging bonds.

Crosslinking can be accomplished in different ways: for instance, there are physical, chemical or thermal methods of crosslinking.

Crosslinking of polymers refers especially to a reaction in which many macromolecules that are linear or branched at first are joined by formation of bridges between the individual macromolecules to give a more or less branched network. The bridges are especially formed by reaction of suitable chemical molecules—called crosslinkers or crosslinker substances—with the macromolecules, for example with particular functional groups of the macromolecules that are particularly attackable by the respective crosslinker molecule. The sites in the crosslinker molecule that attack the macromolecules are generally referred to as “reactive centers”. Crosslinker molecules can join two macromolecules to one another in that one and the same crosslinker molecule reacts with two different macromolecules, i.e. especially has at least two reactive centers, or crosslinker molecules may also have more than two reactive centers, such that one single crosslinker molecule may then also join three or more macromolecules to one another. Intramolecular reactions can occur as a side reaction when one and the same crosslinker molecule attacks one and the same macromolecule with at least two of its reactive centers. In the context of effective crosslinking of the polymer, such side reactions are generally undesirable.

It is possible to distinguish between different types of crosslinkers, namely

1.) covalent crosslinkers, namely those that covalently attack the macromolecules to be joined and hence form a covalent chemical bond between the corresponding reactive center and the site of attack—especially the functional group—on the macromolecule. Useful chemical reactions in principle include all conceivable chemical reactions that form covalent bonds.

2.) coordinative crosslinkers, namely those that coordinatively attack the macromolecules to be joined and hence form a coordinate bond between their corresponding reactive center and the site of attack—especially the functional group—on the macromolecule. Useful chemical reactions in principle include all conceivable chemical reactions that form coordinate bonds.

Specific Execution of the Adhesive Composition Used in Accordance with the Invention

The adhesive composition of layer SK1 or of layer SK2 or preferably of both layers SK1 and SK2, in a particularly preferred embodiment of the invention—referred to hereinafter as “specific embodiment”, are crosslinkable adhesive compositions especially consisting of

(a) at least one first base component comprising

(a1) as the first polymer component a base polymer component (also referred to hereinafter as base polymer for short) composed of a first homopolymer, a copolymer or a homogeneous mixture of two or more homopolymers, two or more copolymers or one or more homopolymers with one or more copolymers,

where at least one of the homopolymers or at least one of the copolymers, especially all the polymers, in the base polymer component have groups that are functional in respect of the crosslinking,

(a2) optionally further constituents that are homogeneously miscible with or soluble in the base polymer component, such as resins or additives, monomer residues, short-chain polymerization products (by-products), impurities etc.;

(b) optionally a second component comprising

(b1) as a further polymer component polymers that are essentially not homogeneously miscible with the base polymer, especially those having no crosslinkable groups,

(b2) optionally further constituents that are essentially not homogeneously miscible with and insoluble in the base polymer, such as particular resins or additives, where component

(f) is especially wholly or partly homogeneously miscible with the further polymer component (b) optionally present;

(c) crosslinkers, namely

(c1) at least one covalent crosslinker,

(c2) at least one coordinative crosslinker,

and

(d) optionally solvents or solvent residues.

The first base component (a) may especially be a polyacrylate component (P) and the second component (b) may especially be an elastomer component (E) within the meaning of the above remarks.

Useful polymers for the base polymer component (a1) for the specific embodiment especially include those polymers and polymer mixtures which can be crosslinked either by covalent or by coordinative crosslinkers. These are especially polymers having free acid groups available for the crosslinking.

Preferred base polymers that can be used are acrylate copolymers, especially those polymers (copolymers, polymer mixtures) that can be derived to an extent of at least 50% by weight from acrylic monomers. Comonomers chosen for the introduction of the crosslinkable groups are copolymerizable monomers having free acid groups, particular preference being given to using acrylic acid. Monomers containing acid groups, for example acrylic acid, have the property of affecting the pressure-sensitive adhesive properties of the pressure-sensitive adhesive composition. If acrylic acid is used, it is preferably used in a proportion up to a maximum of 12.5% by weight, based on the totality of the monomers of the base polymer component. Depending on the amounts of crosslinker used in each case, the amount of acrylic acid included in the polymer is preferably at least sufficient for there to be enough acid groups to result in essentially complete reaction of the crosslinkers.

For its part, the polyacrylate component (a) of the advantageous pressure-sensitive adhesive composition of the specific embodiment preferably constitutes a homogeneous phase. The elastomer component (b) may be intrinsically homogeneous or itself have intrinsic polyphasicity, as known from microphase-separating block copolymers. In the present context, polyacrylate component and elastomer component are chosen such that—after intimate mixing—they are essentially immiscible at 23° C. (i.e. the customary use temperature for adhesive compositions). “Essentially immiscible” means that the components are either not homogeneously miscible with one another at all, such that none of the phases includes a proportion of the second component in a homogeneous mixture, or that the components are partly compatible with one another only to such a minor degree, i.e. one or both components can homogeneously absorb only such a small proportion of the respective other component, that the partial compatibility is not essential to the invention, i.e. is not detrimental to the teaching of the invention. In that case, the corresponding components are considered in the context of the present invention to be “essentially free” of the respective other component.

The advantageous adhesive composition of the specific embodiment is accordingly present in at least biphasic morphology at least at room temperature (23° C.). Very preferably, the polyacrylate component and the elastomer component are essentially not homogeneously miscible within a temperature range from 0° C. to 50° C., even more preferably from −30° C. to 80° C.

The polyacrylate component and/or the elastomer component may each be in the form of 100% systems, i.e. based exclusively on their respective polymer component ((a1) or (b1)) and without further addition of resins, additives or the like. In a further preferred manner, one or both of these two components as well as the base polymer component have been admixed with further components, for example resins.

In an advantageous implementation of the specific embodiment, the polyacrylate component and the elastomer component are composed exclusively of their respective polymer component ((a1) or (b1)), such that no further polymeric components are present, especially no resins. In a development, the polymer component for the entire adhesive composition, apart from the two polymer components (a1) and (b1), does not comprise any further constituents (regardless of crosslinkers in the sense of component (c) and any solvents/solvent residues (d) present).

The polyacrylate component (a) of the advantageous adhesive composition of the specific embodiment especially comprises one or more polyacrylate-based polymers that constitute the base polymer component (a1).

Polyacrylate-based polymers are especially those polymers that can be derived at least predominantly—especially to an extent of more than 60% by weight—from acrylic esters and/or methacrylic acid, and optionally the free acids thereof, as monomers (referred to hereinafter as “acrylic monomers”). Polyacrylates are preferably obtainable by free-radical polymerization. Polyacrylates may optionally contain further units based on further non-acrylic copolymerizable monomers.

The polyacrylates may be homopolymers and/or especially copolymers. The term “copolymer” in the context of this invention encompasses both those copolymers in which the comonomers used in the polymerization are incorporated in a purely random manner and those in which there are gradients in the comonomer composition and/or local enrichments of individual types of comonomer and entire blocks of a monomer in the polymer chains. Alternating comonomer sequences are also conceivable.

The polyacrylates may, for example, be of linear, branched, star-shaped or grafted structure, and they may be homopolymers or copolymers.

Advantageously, the average molar mass (weight-average M_{w}) of at least one of the polyacrylates of the polyacrylate base polymer, and in the case that multiple polyacrylates are present advantageously the predominant proportion by weight of the polyacrylates, especially of all polyacrylates present, is in the range from 250 000 g/mol to 10 000 000 g/mol, preferably in the range from 500 000 g/mol to 5 000 000 g/mol.

In a very preferred procedure, the crosslinkers of component (c) of the specific embodiment are homogeneously miscible into the base component, optionally after prior dissolution in suitable solvents.

Covalent crosslinkers (component (c1)) used for the specific embodiment are preferably glycidylamines. Examples of crosslinkers that are particularly preferred in accordance with the invention include N,N,N′,N′-tetrakis(2,3-epoxypropyl)cyclohexane-1,3-dimethylamine and N,N,N′,N′-tetrakis(2,3-epoxypropyl)-m-xylene-a,a′-diamine.

It is advantageously also possible to use polyfunctional epoxides, especially epoxycyclohexyl carboxylates, as covalent crosslinkers. Particular mention should be made here of 2,2-bis(hydroxymethyl)propane-1,3-diol or (3,4-epoxycyclohexane)methyl 3,4-epoxycyclohexylcarboxylate.

In addition, polyfunctional aziridines may also be used in accordance with the invention.

One example of these is trimethylolpropane tris(2-methyl-1-aziridinepropionate).

Covalent crosslinkers used may further preferably be isocyanates, especially multifunctional isocyanate compounds. The polyfunctional isocyanate compound used may, for example, be tolylene diisocyanate (TDI), tolylene 2,4-diisocyanate dimer, naphthylene 1,5-diisocyanate (NDI), tolylene o-diisocyanate (TODI), diphenylmethane diisocyanate (MDI), triphenylmethane triisocyanate, tris(p-isocyanatophenyl) thiophosphite, polymethylene polyphenyl isocyanate. They may be used alone or in a combination of two or more types thereof.

In the specific embodiment, according to the invention, at least one covalent crosslinker is used, but it is also possible to use two or more covalent crosslinkers, for instance the two aforementioned diamine compounds in combination with one another for example.

Useful coordinative crosslinkers (component (c2)) for the specific embodiment especially include chelate compounds, especially polyvalent metal chelate compounds. The term “polyvalent metal chelate compound” is understood to mean those compounds in which a polyvalent metal is coordinatively bound to one or more organic compounds. Polyvalent metal atoms used may be AI(III), Zr(IV), Co(II), Cu(I), Cu(II), Fe(II), Fe(III), Ni(II), V(II), V(III), V(IV), V(V), Zn(II), In(III), Ca(II), Mg(II), Mn(II), Y(III), Ce(II), Ce(IV), St(II), Ba(II), Mo(II), Mo(IV), Mo(VI), La(III), Sn(II) Sn(IV), Ti(IV) and the like. Among these, preference is given to AI(III), Zr(IV) and Ti(IV).

Ligands used for the coordinative crosslinkers in the specific embodiment may in principle be all known ligands. However, the atoms used for the coordinated binding of the organic compound may especially be those atoms that have free electron pairs, for example oxygen atoms, sulfur atoms, nitrogen atoms and the like. The organic compounds used may, for example, be alkyl esters, alcohol compounds, carboxylic acid compounds, ether compounds, ketone compounds and the like. In particular, titanium chelate compounds such as titanium dipropoxide bis(acetylacetonate), titanium dibutoxide bis(octyleneglycolate), titanium dipropoxide bis(ethylacetoacetate), titanium dipropoxide bis(lactate), titanium dipropoxide bis(triethanolaminate), titanium di-n-butoxide bis(triethanolaminate), titanium tri-n-butoxide monostearate, butyl titanate dimer, poly(titanium acetylacetonate) and the like; aluminum chelate compounds such as aluminum diisopropoxide monoethylacetate, aluminum di-n-butoxide monomethylacetoacetate, aluminum di-i-butoxide monomethylacetoacetate, aluminum di-n-butoxide monoethylacetoacetate, aluminum di-sec-butoxide monoethylacetoacetate, aluminum triacetylacetonate, aluminum triethylacetoacetonate, aluminum monoacetylacetonate bis(ethylacetoacetonate) and the like, and zirconium chelate compounds such as zirconium tetraacetylacetonate and the like are listed for illustrative purposes. Among these, preference is given to aluminum triacetylacetonate and aluminum dipropoxide. They may be used alone or in a combination of two or more types thereof.

Covalent crosslinkers (c1) are used in the specific embodiment preferably in a total amount of 0.015 to 0.04 and preferably 0.02 to 0.035 part by weight, based on 100 parts by weight of the base polymer component (a1), very preferably in an amount of 0.03% by weight.

Coordinative crosslinkers (c2) are used in the specific embodiment preferably in an amount of 0.03 to 0.15 and preferably 0.04 to 0.1 part by weight, based on 100 parts by weight of the base polymer component (a1).

Further preferably, covalent crosslinkers and coordinative crosslinkers are used in the specific embodiment in such a way that the coordinated crosslinkers are present in a molar excess relative to the covalent crosslinkers. Preference is given to using the crosslinkers within the aforementioned ranges, specifically in such a way that the molar ratio of covalent crosslinkers to coordinative crosslinkers—i.e. the ratio of the molar amount n_{cov} of the covalent crosslinkers used to the molar amount n_{coord} of the coordinated crosslinkers used—is in the range from 1:1.3 to 1:4.5; accordingly, 1.3 s n_{coord}/n_{cov} s 4.5. A very preferred molar ratio of covalent crosslinkers to coordinated crosslinkers is from 1:2 to 1:4.

Elastomer Component of the Adhesive Composition Used in Accordance with the Invention, Especially in the Specific Embodiment

As set out above, the adhesive composition used in accordance with the invention, even in the form of its specific embodiment, may comprise polymers that are essentially not homogeneously miscible with the polyacrylate component or the base polymer, especially an elastomer component. For its part, the elastomer component which is essentially incompatible with the polyacrylate component advantageously comprises one or two or more independently selected synthetic rubbers as base polymer component.

The synthetic rubber used is preferably at least one vinylaromatic block copolymer in the form of a block copolymer having an A-B, A-B-A, (A-B)ₙ, (A-B)ₙX or (A-B-A)ₙX, A-B-X(A′-B′)ₙ structure in which
the A or A′ blocks are independently a polymer formed by polymerization of at least one vinylaromatic, for example styrene or a-methylstyrene;
the B or B′ blocks are independently a polymer formed by polymerization of conjugated dienes having 4 to 18 carbon atoms and/or a polymer formed from an isoprene, butadiene, a farnesene isomer or a mixture of butadiene and isoprene or a mixture of butadiene and styrene, or containing entirely or partially ethylene, propylene, butylene and/or isobutylene, and/or a partly or fully hydrogenated derivative of such a polymer;
X is the radical of a coupling reagent or initiator and
n is an integer ≥2.

More particularly, all synthetic rubbers are block copolymers having a structure as detailed above. The synthetic rubber may thus also comprise mixtures of various block copolymers having a construction as above.

Suitable block copolymers (vinylaromatic block copolymers) thus comprise one or more rubber-like blocks B or B′ (soft blocks) and one or more glass-like blocks A or A′ (hard blocks). Particular preference is given to a block copolymer having an A-B, A-B-A, (A-B)₃X or (A-B)₄X construction, where the above meanings are applicable to A, B and X. Most preferably, all synthetic rubbers are block copolymers having an A-B, A-B-A, (A-B)₃X or (A-B)₄X construction, where the above meanings are applicable to A, B and X. More particularly, the synthetic rubber is a mixture of block copolymers having an A-B, A-B-A, (A-B)₃X or (A-B)₄X structure, preferably comprising at least diblock copolymers A-B and/or triblock copolymers A-B-A.

Also advantageous is a mixture of diblock and triblock copolymers and (A-B)ₙ or (A-B)ₙX block copolymers with n not less than 3.

In some advantageous embodiments, a block copolymer which is a multi-arm block copolymer is used additionally or exclusively. This is described by the general formula

Qₘ-Y

in which Q represents one arm of the multi-arm block copolymer and m in turn represents the number of arms, where m is an integer of at least 3. Y is the radical of a multifunctional joining reagent which originates, for example, from a coupling reagent or a multifunctional initiator. More particularly, each arm Q independently has the formula A*-B* where A* and B*, in each case independently of the other arms, are chosen in accordance with the above definition for A/A′ and B/B′, such that each A* represents a vitreous block and B* represents a soft block. It will be appreciated that it is also possible to choose identical A* and/or identical B* for multiple arms Q or all arms Q.

The blocks A, A′ and A* are referred to collectively hereinafter as A blocks. The blocks B, B′ and B* are correspondingly referred to collectively hereinafter as B blocks.

A blocks are generally vitreous blocks each having a glass transition temperature above room temperature (room temperature in the context of this invention shall be understood to mean 23° C.). In some advantageous embodiments, the glass transition temperature of the vitreous block is at least 40° C., preferably at least 60° C., even more preferably at least 80° C. or very preferably at least 100° C.

The vinylaromatic block copolymer generally also has one or more rubber-like B blocks having a glass transition temperature less than room temperature. In some embodiments, the Tg of the soft block is less than −30° C. or even less than −60° C.

As well as the inventive and particularly preferred monomers mentioned for the B blocks, further advantageous embodiments include a polymerized conjugated diene, a hydrogenated derivative of a polymerized conjugated diene or a combination thereof. In some embodiments, the conjugated dienes comprise 4 to 18 carbon atoms.

Preferred conjugated dienes as monomers for the soft block B are especially selected from the group consisting of butadiene, isoprene, ethylbutadiene, phenylbutadiene, piperylene, pentadiene, hexadiene, ethylhexadiene and dimethylbutadiene, and any desired mixtures of these monomers. The B block may also be in the form of a homopolymer or copolymer.

Examples of further advantageous conjugated dienes for the B blocks additionally include ethylbutadiene, phenylbutadiene, piperylene, pentadiene, hexadiene, ethylhexadiene and dimethylbutadiene, where the polymerized conjugated dienes may be in the form of a homopolymer or of a copolymer.

More preferably, the conjugated dienes as monomers for the soft block B are selected from butadiene and isoprene. For example, the soft block B is a polyisoprene, a polybutadiene or a partly or fully hydrogenated derivative of one of these two polymers, such as polybutylene-butadiene in particular, or a polymer formed from a mixture of butadiene and isoprene. Most preferably, the B block is a polybutadiene.

The proportion of A blocks based on the overall block copolymers preferably averages 10% to 40% by weight, more preferably 15% to 33% by weight.

A preferred polymer for A blocks is polystyrene. Preferred polymers for B blocks are polybutadiene, polyisoprene, polyfarnesene and the partly or fully hydrogenated derivatives thereof, such as polyethylene-butylene, polyethylene-propylene, polyethylene-ethylene-propylene or polybutylene-butadiene or polyisobutylene. Polybutadiene is very preferred.

Mixtures of different block copolymers may be used. Preference is given to using triblock copolymers ABA and/or diblock copolymers AB.

Block copolymers may be linear, radial or star-shaped (multi-arm).

Further Components of the Adhesive Composition Used in Accordance with the Invention, Especially in the Specific Embodiment

The adhesive compositions used in accordance with the invention may especially be resin-free since the polyacrylate component is frequently itself already pressure-sensitively adhesive, and the pressure-sensitive adhesive character is conserved even when the elastomer component is present. Nevertheless, it may be of interest to further improve the adhesive properties or to optimize them for specific applications; therefore, in an advantageous development of the invention, the adhesive compositions may be admixed with tackifying resins.

The use of tackifiers, also referred to as tackifying resins, for increasing the bonding forces of pressure-sensitive adhesives is known in principle. Preferably, 15 to 100 parts by weight of tackifier (based on the polymers, i.e. acrylates plus any elastomers such as synthetic rubbers) are added to the self-adhesive acrylate composition, usually 20 to 80 parts by weight, further preferably 30 to 50 parts by weight.

A “tackifying resin”, in accordance with the general understanding of the person skilled in the art, is understood to mean an oligomeric or polymeric resin that increases autoadhesion (tack, intrinsic tackiness) of the pressure-sensitive adhesive composition compared to the pressure-sensitive adhesive composition that does not contain any tackifying resin but is otherwise identical.

Suitable tackifiers are in principle all known substance classes. Tackifiers are, for example, unhydrogenated or partially, selectively or fully hydrogenated hydrocarbon resins (for example polymers based on unsaturated C₅, C₅/C₉ or C₉ monomers), terpene-phenol resins, polyterpene resins based on raw materials, for example α-, β-pinene and/or δ-limonene, aromatic resins such as coumarone-indene resins or resins based on styrene or a-methylstyrene such as rosin and its conversion products, for example disproportionated, dimerized or esterified rosin, for example reaction products with glycol, glycerol or pentaerythritol, to mention just a few. Preference is given to resins having no readily oxidizable double bonds, such as terpene-phenol resins, aromatic resins and more preferably resins prepared by hydrogenation, for example hydrogenated aromatic resins, hydrogenated polycyclopentadiene resins, hydrogenated rosin derivatives or hydrogenated polyterpene resins.

Preference is given to resins based on terpene-phenols and rosin esters. Preference is likewise given to tackifying resins having a softening point above 80° C. according to ASTM E28-99 (2009). Particular preference is given to resins based on terpene-phenols and rosin esters having a softening point above 90° C. according to ASTM E28-99 (2009).

To further improve the properties, the adhesive composition formulation may optionally have been blended with light stabilizers or primary and/or secondary aging stabilizers.

Aging stabilizers used may be products based on sterically hindered phenols, phosphites, thiosynergists, sterically hindered amines or UV absorbers.

Preference is given to using primary antioxidants, for example Irganox 1010 or Irganox 254, alone or in combination with secondary antioxidants, for example Irgafos TNPP or Irgafos 168.

The aging stabilizers may be used in any combination with one another, and mixtures of primary and secondary antioxidants in combination with light stabilizers, for example Tinuvin 213, show particularly good anti-aging action.

Very particularly advantageous aging stabilizers have been found to be those in which a primary antioxidant is combined with a secondary antioxidant in one molecule. These aging stabilizers are cresol derivatives wherein the aromatic ring is substituted by thioalkyl chains at any two different positions, preferably in ortho and meta position to the OH group, where the sulfur atom may also be bonded via one or more alkyl chains to the aromatic ring of the cresol unit. The number of carbon atoms between the aromatic system and the sulfur atom may be between 1 and 10, preferably between 1 and 4. The number of carbon atoms in the alkyl side chain may be between 1 and 25, preferably between 6 and 16. Particular preference is given here to compounds of the 4,6-bis(dodecylthiomethyl)-o-cresol, 4,6-bis(undecylthiomethyl)-o-cresol, 4,6-bis(decylthiomethyl)-o-cresol, 4,6-bis(nonylthiomethyl)-o-cresol or 4,6-bis(octylthiomethyl)-o-cresol type. Aging stabilizers of this kind are applied, for example, by Ciba Geigy under the Irganox 1726 or Irganox 1520 name.

The amount of the aging stabilizer or aging stabilizer package added should be within a range between 0.1 and 10 parts by weight, preferably within a range between 0.2 and 5 parts by weight, more preferably within a range between 0.5 and 3 parts by weight, based on the polymer content (acrylates plus any elastomers such as synthetic rubbers).

To improve the processing properties, the formulation may also have been blended with customary processing auxiliaries such as rheology additives (thickeners), defoamers, deaerating agents, wetting agents or leveling agents. Suitable concentrations are within the range from 0.1 up to 5 parts by weight based on the polymer content (acrylates plus any elastomers such as synthetic rubbers).

Fillers (reinforcing or non-reinforcing) such as silicon dioxides (spherical, acicular, in platelet form or in irregular form, such as the fumed silicas), calcium carbonates, zinc oxides, titanium dioxides, aluminum oxides or aluminum oxide hydroxides may serve to adjust either processibility or the adhesive properties. Suitable concentrations are within the range from 0.1 up to 20 parts by weight based on the polymer content (acrylates plus any elastomers such as synthetic rubbers).

The self-adhesive acrylate composition that forms layers SK1 and/or SK2, in a preferred embodiment of the invention, comprises a polymer mixture of acrylates and synthetic rubbers, where one or more crosslinkers and tackifiers have been mixed into the polymer composition.

In a further preferred embodiment, layer SK1 or layer SK2 contains, or preferably both layers SK1 and SK2 contain, a black pigment such as carbon black. More preferably, the proportion is 0.1 part by weight and 10 parts by weight based on the overall composition of the respective layer.

### Foaming and Configuration of the Self-Adhesive Acrylate Composition Layers

According to the invention, layers SK1 and SK2 have been foamed.

Preferably, the foam is obtained by the introduction and subsequent expansion of microballoons. “Microballoons” are understood to mean hollow microbeads that are elastic and hence expandable in their ground state, having a thermoplastic polymer shell. These beads have been filled with low-boiling liquids or liquefied gas. Shell material employed is especially polyacrylonitrile, PVDC, PVC or polyacrylates. Suitable low-boiling liquids are especially hydrocarbons from the lower alkanes, for example isobutane or isopentane, that are enclosed in the polymer shell under pressure as liquefied gas.

Action on the microballoons, especially by the action of heat, results in softening of the outer polymer shell. At the same time, the liquid blowing gas present within the shell is converted to its gaseous state. This causes irreversible extension and three-dimensional expansion of the microballoons. The expansion has ended when the internal and external pressure are balanced. Since the polymeric shell is conserved, what is achieved is thus a closed-cell foam.

A multitude of microballoon types are commercially available, which differ essentially in terms of their size (diameter 6 to 45 μm in the unexpanded state) and the starting temperatures that they require for expansion (75 to 220° C.). One example of commercially available microballoons is the Expancel® DU products (DU=dry unexpanded) from Akzo Nobel.

Unexpanded microballoon products are also available in the form of an aqueous dispersion having a solids/microballoon content of about 40% to 45% by weight, and additionally also in the form of polymer-bound microballoons (masterbatches), for example in ethylene-vinyl acetate with a microballoon concentration of about 65% by weight. Both the microballoon dispersions and the masterbatches, like the DU products, are suitable for production of a foamed pressure-sensitive adhesive composition of the invention.

Foamed layers SK1 and SK2 can also be produced with what are called pre-expanded microballoons. According to the invention, one of layers SK1 and SK2 or both layers SK1 and SK2 may have been foamed in this way. In the case of pre-expanded microballoons, expansion already takes place prior to mixing into the polymer matrix. Pre-expanded microballoons are commercially available, for example, under the Dualite® name or with the product designation Expancel xxx DE yy (dry expanded) from Akzo Nobel.“xxx” represents the composition of the microballoon blend. “yy” represents the size of the microballoons in the expanded state.

In the processing of already expanded microballoon types, it is possible that the microballoons, because of their low density in the polymer matrix into which they are to be incorporated, will have a tendency to float, i.e. to rise “upward” in the polymer matrix during the processing operation. This leads to inhomogeneous distribution of the microballoons in the layer. In the upper region of the layer (z direction), more microballoons are to be found than in the lower region of the layer, such that a density gradient across the layer thickness is established.

This case is shown in FIG. 2. What can be seen here is a gradient in the distribution of the microballoons. In the upper region of the foam layer there are more and, in particular, further-expanded microballoons than in the lower region of the foam layer.

In order to largely or very substantially prevent such a density gradient, preference is given in accordance with the invention to incorporating only a low level of, if any, pre-expanded microballoons into the polymer matrix of layer SK1 or of layer SK2 or preferably of both layers SK1 and SK2. Only after the incorporation into the layer are the microballoons expanded.

In this way, a more homogeneous distribution of the microballoons in the polymer matrix is obtained (see FIG. 3). What can be seen in FIG. 3 is that microballoons expanded to the same extent are present both in the upper region and in the lower region of the foam layer.

The degree of expansion of the microballoons is also more balanced overall. Virtually all microballoons have expanded equally.

Preferably, the microballoons are chosen such that the ratio of the density of the polymer matrix to the density of the (non-pre-expanded or only slightly pre-expanded) microballoons to be incorporated into the polymer matrix is between 1 and 1:6, i.e.:

$$\frac{Density of the polymer matrix}{Density of the microballoons to be incorporated} = 1 to 1.6$$

Expansion then follows immediately after or occurs directly in the course of incorporation. In the case of solvent-containing compositions, the microballoons are preferably expanded only after incorporation, coating, drying (solvent evaporation).

Preference is therefore given in accordance with the invention to using DU products.

Preferably in accordance with the invention, at least 90% of all voids formed by microballoons in layer SK1 or layer SK2 or preferably in both layers SK1 and SK2 have a maximum diameter of 7 to 200 μm, more preferably of 10 to 100 μm, most preferably of 10 to 30 μm. The “maximum diameter” is understood to mean the maximum extent of a microballoon in any spatial direction.

If the pressure-sensitive adhesive composition used in accordance with the invention is an acrylate composition blended with an elastomer component, the size of the elastomer domains in their greatest extent is typically between 0.5 μm and 150 μm, especially between 1 μm and 30 μm; see above. In a particularly preferred manner, in that case, the maximum diameter of the voids formed by at least 90% of all microballoons and the maximum diameter of at least 90% of the domains of the elastomer component within the same size range are below 100 μm, especially in each case in the range between 10 μm and 30 μm.

The diameter is determined using a cryofracture edge in a scanning electron microscope (SEM) at 500-fold modification. For each individual microballoon, the diameter is ascertained by graphical means.

If foaming is effected by means of microballoons, the microballoons can then be supplied to the formulation as a batch, paste or unblended or blended powder. In addition, they may be suspended in solvents.

The proportion of the microballoons in layer SK1 or layer SK2 or preferably both layers SK and SK2, in a preferred embodiment of the invention, is between greater than 0% by weight and 12% by weight, especially between 0.25% parts and 5% by weight, more preferably between 0.5% and 3% by weight, based in each case on the overall composition (including mixed-in microballoons) of the corresponding layer SK1 or SK2.

The figures are each based on unexpanded microballoons.

A polymer composition containing expandable hollow microspheres for layer SK or layer SK2 or both layers SK1 and SK2 may additionally also contain nonexpandable hollow microbeads. What is crucial is merely that virtually all gas-containing caverns are closed by a permanently impervious membrane, no matter whether this membrane consists of an elastic and thermoplastically extensible polymer mixture or, for instance, of elastic and—within the spectrum of the temperatures possible in plastics processing—non-thermoplastic glass.

Also suitable for layers SK1 and SK2—selected independently of other additives—are solid polymer beads such as PMMA beads, hollow glass beads, solid glass beads, phenolic resin beads, hollow ceramic beads, solid ceramic beads and/or solid carbon beads (“carbon microballoons”). The additives mentioned here may also be present either in just one of layers SK1 or SK2 orin both layers SK1 and SK2.

The absolute density of the foamed layer SK1 or layer SK2 or preferably of both layers SK and SK2 is preferably 350 to 950 kg/m³, more preferably 450 to 930 kg/m³, especially 570 to 880 kg/m³.

The relative density describes the ratio of the density of the respectively foamed layer to the density of the corresponding unfoamed layer having an identical formulation. The relative density of layer SK1 or layer SK2 or preferably of both layers SK1 and SK2 is preferably 0.35 to 0.99, more preferably 0.45 to 0.97, especially 0.50 to 0.90.

### Film Carrier

Materials used for the film of the preferably nonextensible film carrier F are preferably polyesters, especially polyethylene terephthalate (PET), polyamide (PA), polyimide (PI) or mono- or biaxially stretched polypropylene (PP). It is likewise possible also to use multilayer laminates or co-extrudates, especially composed of the aforementioned materials. Preferably, the film carrier has a single layer.

In a very advantageous manner, one of the surfaces has or both surfaces of the film carrier layer have been physically and/or chemically pretreated, for instance by etching and/or corona treatment and/or plasma treatment and/or primer treatment.

In order to achieve very good results for the roughening, it is advisable to use, as reagent for etching of the film, trichloroacetic acid (Cl₃C—COOH) or trichloroacetic acid in combination with inert crystalline compounds, preferably silicon compounds, more preferably [SiO₂]ₓ.

The point of the inert crystalline compounds is to be incorporated into the surface of the film, especially the PET film, in order in this way to enhance the roughness and surface energy.

Corona treatment is a chemical/thermal process for enhancing the surface tension/surface energy of polymeric substrates. Electrons are greatly accelerated in a high-voltage discharge between two electrodes, which leads to ionization of the air. If a plastics substrate is introduced into the path of these accelerated electrodes, the accelerated electrodes thus produced hit the substrate surface with 2-3 times the energy that would be needed to break the molecular bonds at the surface of most substrates. This leads to formation of gaseous reaction products and of highly reactive free radicals. These free radicals can react rapidly in the presence of oxygen and the reaction products and form various chemical functional groups at the substrate surface. Functional groups that result from these oxidation reactions make the greatest contribution to increasing the surface energy. Corona treatment can be effected with two-electrode systems, or else with one-electrode systems.

During the corona pretreatment, (as well as the usual air) it is possible to use different process gases such as nitrogen that form a protective gas atmosphere or promote the corona pretreatment.

The plasma treatment—especially low-pressure plasma treatment—is a known process for surface pretreatment of adhesive compositions. The plasma leads to activation of the surface in the sense of a higher reactivity. This results in chemical changes to the surface, as a result of which, for example, the characteristics of the adhesive composition with respect to polar and nonpolar surfaces can be influenced. This pretreatment essentially comprises surface phenomena.

Primers refer generally to coatings or basecoats which especially have an adhesion-promoting and/or passivating and/or corrosion-inhibiting effect. In the context of the present invention, it is the adhesion-promoting effect that is especially important. Adhesion-promoting primers, often also called adhesion promoters, are in many cases known in the form of commercial products or from the technical literature.

The thickness of the film, in a preferred embodiment, is between 5 and 250 μm, preferably between 6 and 120 μm, especially between 12 and 100 μm, very particularly between 23 and 50 μm.

Preferably, the film is made of polyethylene terephthalate and has a thickness between 23 and 50 μm.

A suitable film is available under the Hostaphan® RNK trade name. This film is highly transparent and biaxially oriented and consists of three coextruded layers.

For production of the film, it may be appropriate to add additives and further components that improve the film-forming properties, reduce the tendency to formation of crystalline segments and/or selectively improve or else, if appropriate, worsen the mechanical properties.

In the context of the present application, nonextensible films are considered to be those that fulfill the values which follow for tensile strength and/or elongation at break (values reported in relation to the R1 test method specified later on).

The tensile strength of the film in longitudinal direction and in transverse direction is preferably greater than 100 N/mm² in each case, preferably greater than 150 N/mm². In a very preferred manner, the tensile strength of the film is greater than 100 N/mm², even further preferably greater than 180 N/mm² (in longitudinal direction), and greater than 200 N/mm², even further preferably greater than 270 N/mm² (in transverse direction).

The elongation at break of the film is preferably less than 300%, preferably less than 200% (in longitudinal direction), and less than 300%, preferably less than 120% (in transverse direction), where these values can be implemented independently of those specified for tensile strength or simultaneously.

The film is crucial in determining the tensile strength and/or elongation at break of the pressure-sensitive adhesive strip. Preferably, the pressure-sensitive adhesive strip has the same values as specified above for tensile strength and elongation at break.

### Production and Configuration of the Pressure-Sensitive Adhesive Strip

The production and processing of the pressure-sensitive adhesive compositions can be effected either from solution or from the melt. The application of the pressure-sensitive adhesive compositions can be effected by direct coating or by lamination, especially hot lamination.

Preferably, the thickness of the self-adhesive composition layers SK1 and SK2 is between 10 and 500 μm in each case.

Advantageously, the outer, exposed faces of the outer adhesive composition layers SK1 and/or SK2 of the pressure-sensitive adhesive strip of the invention can be provided with materials having an anti-adhesive coating on both sides, such as a release paper or a release film, also called liner, specifically as a temporary carrier.

A liner (release paper, release film) is not part of an adhesive tape, but merely an auxiliary for production and/or storage thereof and/or for further processing by die-cutting. Furthermore, a liner, by contrast with an adhesive tape carrier, is not firmly bonded to an adhesive layer.

Typical supply forms of the pressure-sensitive adhesive strips of the invention are adhesive tape rolls and adhesive strips as obtained, for example, in the form of die-cut parts.

Preferably, all layers are essentially in the shape of a cuboid. Further preferably, all layers are bonded to one another over the full area. This bond can be optimized by the pretreatment of the film surfaces.

The general expression “adhesive strip” (pressure-sensitive adhesive strip), or else synonymously “adhesive tape” (pressure-sensitive adhesive tape), in the context of this invention, encompasses all sheetlike structures such as films or film sections extending in two dimensions, tapes having extended length and limited width, tape sections and the like, and lastly also die-cut parts or labels.

The pressure-sensitive adhesive strip thus has a longitudinal extent (x direction) and a lateral extent (y direction). The pressure-sensitive adhesive strip also has a thickness (z direction) that runs perpendicular to the two extents, the lateral extent and longitudinal extent being several times greater than the thickness. The thickness is very substantially the same, preferably exactly the same, over the entire areal extent of the pressure-sensitive adhesive strip determined by its length and width.

The pressure-sensitive adhesive strip of the invention is especially in sheet form. A sheet is understood to mean an object, the length of which (extent in the x direction) is several times greater than its width (extent in the y direction), and the width over the entire length remains roughly and preferably exactly the same.

The pressure-sensitive adhesive strip, especially in sheet form, can be produced in the form of a roll, i.e. in the form of a rolled-up Archimedean spiral.

The three-layer pressure-sensitive adhesive strip (i.e. neglecting any liners present) preferably has a thickness of 20 μm to 6000 μm, more preferably of 30 μm to 500 μm, especially preferably of 45 μm to 350 μm.

### Crosslinking of the Adhesive Composition Layers

Layer SK1 composed of a self-adhesive composition or layer SK2 composed of a self-adhesive composition or preferably both layers SK1 and SK2 are very preferably in crosslinked form in the pressure-sensitive adhesive strip of the invention. The crosslinking preferably takes place in the pressure-sensitive adhesive composition in the form of a layer or of a film.

The crosslinking reaction may especially proceed as follows:

In an advantageous procedure, the two substances are applied to the polymer in solution as a pure substance or predissolved in a suitable solvent, then the polymer is mixed thoroughly with the crosslinkers, coated onto a temporary or permanent carrier and then dried under suitable conditions, under which the crosslinking takes place.

In an optional procedure especially suitable for very reactive systems, first of all, one of the crosslinkers is added to the polymer solution in pure or predissolved form. The second crosslinker is not fed in until shortly before the coating, for example via inline metered addition with a downstream active or static mixer and subsequent coating and drying.

The pot life (processing time) of the coordinative crosslinkers can be increased by adding the above-described ligands to the polymer/crosslinker solution. The ligand excess is then removed in the course of drying; only then are the coordinative crosslinkers (fully) reactive.

The drying conditions (temperature and residence time) are very preferably chosen such that not only is the solvent removed but the crosslinking is also complete to a large degree, such that a stable level of crosslinking—especially at relatively high temperatures—is achieved. More particularly, the adhesive composition is fully crosslinked.

Crosslinking of an adhesive composition is understood in accordance with the invention to mean that the maximum shear travel “max” in the micro-shear travel test, under the conditions specified therein, in the case of repeated (for example daily) micro-shear measurement within a period of 48 hours, changes only within the accuracy of the test method (for instance up to a maximum of 5%) when the adhesive composition is stored at room temperature (23° C.) under otherwise standard conditions.

According to the field of use of the adhesive composition, the detection of complete crosslinking can also be conducted for other temperatures (for example 40° C., especially those temperatures that correspond to the respective use temperatures).

In an advantageous manner, the pressure-sensitive adhesive strip of the invention can be used for bonding of components for precision-mechanical, optical, electrical and/or electronic devices, for example in the manufacture, repair or decoration thereof or the like. Examples of materials used for bonding here may include plastics, glasses, metals and the like.

The pressure-sensitive adhesive strip of the invention is especially also suitable for permanent bonding of flexible materials, especially in the manufacture of flexible displays. Displays of this kind are increasing in importance.

In an advantageous manner, the pressure-sensitive adhesive strip of the invention can be used for bonding of windows or lenses in housings of precision-mechanical, optical and/or electronic devices (called “lens mounting”). In this case, at least one of the rigid or flexible substrates is transparent or translucent. The transparent or translucent substrate may, for example, be a window or an optical lens for the purpose of protection of sensitive components arranged beneath—such components may, for example, be liquid-crystal displays (LCDs), light-emitting diodes (LEDs) or organic light-emitting diodes (OLEDs) of displays, but also printed circuits or other sensitive electronic components; this plays a major role, for example, in use for touch-sensitive displays—and/or to bring about optical effects for the function of the device—for example refraction of light, concentration of light, attenuation of light, amplification of light etc.

Very advantageously, the transparent substrate is chosen such that it has a haze value of not more than 50%, preferably of not more than 10%, very preferably of not more than 5% (measured according to ASTM D 1003).

The second substrate is preferably likewise a component of a precision-mechanical, optical and/or electronic device. Conceivable examples here are housings of such devices or holders for windows or lenses as described above.

In a preferred procedure, the transparent or translucent substrate is a substrate made of glass, polymethylmethacrylate and/or polycarbonate.

More particularly, the second substrate may consist of plastics such as acrylonitrile-butadiene-styrene copolymers (ABS), polyamide or polycarbonate, which may especially also be glass fiber-reinforced; or of metals such as aluminum—including anodized (eloxed) aluminum—or magnesium and metal alloys.

Additives, for example dyes, light stabilizers, aging stabilizers, plasticizers or the like, may also have been added to the substrate materials if this is advantageous for the intended end use, and in the case of transparent or translucent materials more particularly to such an extent that it impairs these optical properties only to an acceptable degree, if at all.

According to the invention, the composite of the invention is thus a component of an electronic, optical or precision-mechanical device as cited in the table above.

### Advantageous Configurations of the Pressure-Sensitive Adhesive Strip of the Invention

With reference to the figures and examples described hereinafter, particularly advantageous embodiments of the invention will be elucidated in detail, without any intention to unnecessarily restrict the invention thereby.

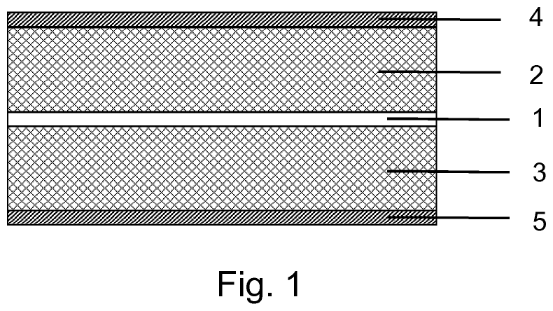

FIG. 1 shows the schematic construction of a three-layer pressure-sensitive adhesive strip of the invention, composed of three layers 1, 2, 3 in cross section.

The strip comprises a non-extensible film carrier 1 (layer F) in the form of a PET film that has been etched on both sides.

On the top side and on the bottom side of the PET film 1 there are two outer self-adhesive composition layers 2, 3 (layer SK1 and layer SK2).

The self-adhesive composition layers 2, 3 (layers SK1 and SK2) are covered in turn by a liner 4, 5 on each side in the illustrative embodiment shown.

In a production process of the invention, all constituents of the adhesive composition are dissolved in a solvent mixture (benzine/toluene/acetone). The microballoons have been converted to a slurry in benzine and stirred into the dissolved adhesive composition. For this purpose, it is possible in principle to use the known compounding and stirring units, and it should be ensured that the microballoons do not yet expand in the course of mixing. As soon as the microballoons are distributed homogeneously in the solution, the adhesive composition can be coated, for which it is again possible to use prior art coating systems.

For example, the coating can be accomplished by means of a doctor blade onto a conventional PET liner. In the next step, the adhesive composition layer thus produced is dried at 100° C. for 15 min.

In none of the aforementioned steps is there any expansion of the microballoons.

The nonextensible film layer F is laminated onto the free surface of the adhesive composition layer thus produced and dried. Laminated on the second surface thereof is the free surface of a second, likewise dried adhesive composition layer produced in this way, so as to result in an unfoamed three-layer composite composed of the inner film layer and two adhesive composition layers provided with liners.

Alternatively, the film layer F can be directly coated simultaneously or subsequently with the unfoamed adhesive compositions that have been provided with microballoons, and then these still-exposed adhesive composition layers are dried at 100° C. for 15 min and then covered with liners, so as to result in the unfoamed three-layer composite.

After the drying, the adhesive layers are foamed in the oven within an appropriate temperature/time window, for instance at 150° C. for 5 min or at 170° C. for 1 min, specifically covered between the two liners, in order to produce a particularly smooth surface.

The surface thus produced has a roughness Rₐ of less than 15 μm, more preferably less than 10 μm, most preferably less than 3 μm.

The surface roughness is preferably Rₐ is a unit for the industrial standard for the quality of the final surface processing and constitutes the average height of the roughness, especially the average absolute distance from the center line of the roughness profile within the range of evaluation. This is measured by means of laser triangulation.

The expansion temperature chosen is especially higher than drying temperature in order to avoid the expansion of the microballoons in the course of drying.

### Properties of the Pressure-Sensitive Adhesive Strips of the Invention

The pressure-sensitive adhesive strips of the invention are notable for an excellent application profile that fulfills the demands of the stated object of the invention. It has been found here that the shock absorption capacity in particular is better than in prior art products, especially also with regard to four-layer products of equal thickness composed of PET carrier, foamed inner layer and outer pressure-sensitive adhesive composition layers.

The invention is elucidated in detail hereinafter by a few examples.

### EXAMPLES

### Base Polymers, Blends

There follows a description of the preparation of the starting polymer and the blends comprising microballoons that are produced therefrom. The polymers examined are prepared conventionally via a free-radical polymerization in solution.

### Base Polymer P1

A conventional reactor for free-radical polymerizations was charged with 47.5 kg of 2-ethylhexyl acrylate, 47.5 kg of n-butyl acrylate, 5 kg of acrylic acid and 66 kg of benzine/acetone (70/30). After passing nitrogen gas through for 45 minutes with stirring, the reactor was heated up to 58° C. and 50 g of AIBN were added. Subsequently, the external heating bath was heated to 75° C. and the reaction was conducted constantly at this external temperature. After 1 h, another 50 g of AIBN were added and, after 4 h, the mixture was diluted with 20 kg of benzine/acetone mixture.

After 5.5 and after 7 h, 150 g each time of further bis(4-tert-butylcyclohexyl) peroxydicarbonate initiator were added. After a reaction time of 22 h, the polymerization was stopped and the mixture was cooled to room temperature. The polyacrylate has an average molecular weight of M_{w}=386 000 g/mol, polydispersity PD (Mw/Mn)=7.6.

### Example: Pressure-Sensitive Adhesive Composition B1

A mixture comprising 42.425% by weight, based on the dry weight of the polymer, of the base polymer P1, 37.5% by weight of the resin Dertophene T and 20% by weight of Kraton D 1118 is prepared. A solids content of 38% is established by the addition of benzine. The mixture of polymer and resin is stirred until the resin has visibly fully dissolved. Thereafter, 0.075% by weight of the covalent crosslinker Erysis GA 240 (N,N,N′,N′-tetrakis(2,3-epoxypropyl)-m-xylene-a,a′-diamine from Emerald Performance Materials, CAS NO. 63738-22-7) is added. The mixture is stirred at room temperature for 15 minutes.

During this period, for production of blends 1, 2, 3, 9 and 10, the amounts of microballoons (Expancel 920 DU20) specified in table 2 are added.

### Example: Pressure-Sensitive Adhesive Composition B2

A mixture comprising 42.34% by weight, based on the dry weight of the polymer, of the base polymer P1, 35.25% by weight of the resin Dertophene T and 17% by weight of Kraton D 1118 is prepared. A solids content of 38% is established by the addition of benzine. The mixture of polymer and resin is stirred until the resin has visibly fully dissolved. Thereafter, 0.035% by weight of the covalent crosslinker Erysis GA 240 (a tetrafunctional epoxy resin based on meta-xylenediamine, CAS NO. 63738-22-7) and 0.075% by weight of Al chelate are added. The mixture is stirred at room temperature for 15 minutes.

During this period, 1.25% by weight of microballoons (Expancel 920 DU20) and 3% by weight of Hostatint are added (production of blend 4).

### Example: Pressure-Sensitive Adhesive Composition B3

A mixture comprising 29.925% by weight, based on the dry weight of the polymer, of the base polymer P1, 30% by weight of the resin Dertophene T and 40% by weight of Kraton D 1118 is prepared. A solids content of 38% is established by the addition of benzine. The mixture of polymer and resin is stirred until the resin has visibly fully dissolved. Thereafter, 0.075% by weight of the covalent crosslinker Erysis GA 240 (a tetrafunctional epoxy resin based on meta-xylenediamine, CAS NO. 63738-22-7) are added. The mixture is stirred at room temperature for 15 minutes.

During this period, for production of blends 5 to 8, the amounts of microballoons (Expancel 920 DU20) specified in table 2 are added.

### Example: Pressure-Sensitive Adhesive Composition B4

A mixture comprising 42.34% by weight, based on the dry weight of the polymer, of the base polymer P1, 35.25% by weight of the resin Dertophene T and 17% by weight of Kraton D 1118 is prepared. A solids content of 38% is established by the addition of benzine. The mixture of polymer and resin is stirred until the resin has visibly fully dissolved. Thereafter, 0.035% by weight of the covalent crosslinker Erysis GA 240 (a tetrafunctional epoxy resin based on meta-xylenediamine, CAS NO. 63738-22-7) and 0.075% by weight of Al chelate are added. The mixture is stirred at room temperature for 15 minutes.

During this period, for production of blends 11 to 14, the amounts of microballoons (Expancel 920 DU20) specified in table 2 are added.
Kraton 1118 styrene-butadiene-styrene block copolymer from Kraton Polymers 78% by weight of 3-block, 22% by weight of 2-block; block polystyrene content: 33% by weight
   (molecular weight M_{w} of the 3-block content of 150 000 g/mol)
Dertophene T terpene-phenol resin (softening point 110° C.; M_{w}=500 to 800 g/mol; D=1.50), DRT resins, 25359-84-6
Al chelate: Al(III) acetylacetonate (from Sigma Aldrich)
Expancel 920 DU20 microballoons
Hostatint black pigment from Clariant

TABLE 1

| | PSA | PSA | PSA | PSA |
|---|---|---|---|---|
| | compo- | compo- | compo- | compo- |
| | sition 1 | sition 2 | sition 3 | sition 4 |
| | Propor- | Propor- | Propor- | Propor- |
| Raw | tion (% | tion (% | tion (% | tion (% |
| material | by wt.) | by wt.) | by wt.) | by wt.) |
| Acrylate | 42.425 | 42.39 | 29.925 | 59.925 |
| Kraton 1118 | 20 | 20 | 40 | — |
| Dertophene T | 37.5 | 37.5 | 30 | 40 |
| Erysis GA 240 | 0.075 | 0.035 | 0.075 | 0.075 |
| AI chelate | — | 0.075 | — | — |
| Total | 100 | 100 | 100 | 100 |

TABLE 2

| | Base composition | Microballoons * | Black pigment * |
|---|---|---|---|
| Blend 1 | PSA composition 1 | 2.3% by wt. | — |
| Blend 2 | PSA composition 1 | 1.25% by wt. | — |
| Blend 3 | PSA composition 1 | 0.8% by wt. | — |
| Blend 4 | PSA composition 2 | 1.25% by wt. | 3% by wt. |
| Blend 5 | PSA composition 3 | 0.8% by wt. | — |
| Blend 6 | PSA composition 3 | 1.5% by wt. | — |
| Blend 7 | PSA composition 3 | 2.3% by wt. | — |
| Blend 8 | PSA composition 3 | 3.5% by wt. | — |
| Blend 9 | PSA composition 1 | 1.5% by wt. | — |
| Blend 10 | PSA composition 1 | 3.5% by wt. | — |
| Blend 11 | PSA composition 4 | 0.8% by wt. | — |
| Blend 12 | PSA composition 4 | 1.2% by wt. | — |
| Blend 13 | PSA composition 4 | 2.3% by wt. | — |
| Blend 14 | PSA composition 4 | 3.5% by wt. | — |

* Figures based on 100% by weight of blended adhesive composition in each case (composed of base composition, microballoons and, if present, black pigment)

### Production of the Pressure-Sensitive Adhesive Strips

The respective blends for production of the microballoon-containing layer are coated at the desired basis weight (cf. table 3) onto a process liner (siliconized film). The layers thus obtained are dried (100° C. for 15 min) and used as layers SK1 and SK2 for the pressure-sensitive adhesive tapes.

Three-layer symmetric pressure-sensitive adhesive tapes (examples 1 to 28, comparative examples 3 and 4) are obtained by laminating the respective layers SK1 and SK2—present on the process liner, still unfoamed—by their respective exposed self-adhesive composition surfaces onto the two pretreated surfaces of a PET film (pre-treatment of the surfaces according to the details in table 3: “corona” therein is an abbreviation of corona pretreatment).

Thereafter, the foaming step takes place with the composite thus obtained, with simultaneous foaming of the two layers SK1 and SK2.

Four-layer comparative pressure-sensitive adhesive tapes (comparative examples 1 and 2) are obtained by laminating a dried, microballoon-containing adhesive composition layer (according to the details in table 3) by their free pressure-sensitive adhesive surface onto a PET film that has been etched on both sides. Thereafter, an optionally dried layer of the outer pressure-sensitive adhesive compositions, present on a process liner, is laminated onto each of the outer surfaces of the composite composed of PET film and microballoon-containing layer thus obtained.

The last step of the respective adhesive strip production comprises the foaming of the layers of the respective pressure-sensitive adhesive strip that are to be foamed by the action of hot air (about 170° C.) a for about one minute.

As required, one or both of the outer liners are removed again for the studies.

By the aforementioned processes, the following pressure-sensitive adhesive strips according to table are produced:

TABLE 3

| | | Total thickness |
|---|---|---|
| Example | Layer sequence | (after foaming) |
| Example 1 | 41 g/m² of blend 1 | 150 μm |
| | 23 μm of corona PET | |
| | 41 g/m² of blend 1 | |
| Example 2 | 90 g/m² of blend 1 | 300 μm |
| | 23 μm of corona PET | |
| | 90 g/m² of blend 1 | |
| Example 3 | 54 g/m² of blend 3 | 150 μm |
| | 23 μm of corona PET | |
| | 54 g/m² of blend 3 | |
| Example 4 | 44 g/m² of blend 7 | 150 μm |
| | 23 μm of etched PET | |
| | 44 g/m² of blend 7 | |
| Example 5 | 98 g/m² of blend 7 | 300 μm |
| | 23 μm of etched PET | |
| | 98 g/m² of blend 7 | |
| Example 6 | 54 g/m² of blend 5 | 150 μm |
| | 23 μm of etched PET | |
| | 54 g/m² of blend 5 | |
| Example 7 | 38 g/m² of blends | 110 μm |
| | 23 μm of etched PET | |
| | 38 g/m² of blend 5 | |
| Example 8 | 33 g/m² of blend 6 | 110 μm |
| | 23 μm of etched PET | |
| | 33 g/m² of blend 6 | |
| Example 9 | 30 g/m² of blend 7 | 110 μm |
| | 23 μm of etched PET | |
| | 30 g/m² of blend 7 | |
| Example 10 | 25 g/m² of blend 8 | 110 μm |
| | 23 μm of etched PET | |
| | 25 g/m² of blend 8 | |
| Example 11 | 94 g/m² of blend 1 | 300 μm |
| | 23 μm of etched PET | |
| | 94 g/m² of blend 1 | |
| Example 12 | 43 g/m² of blend 1 | 150 μm |
| | 23 μm of etched PET | |
| | 43 g/m² of blend 1 | |
| Example 13 | 56 g/m² of blend 3 | 150 μm |
| | 23 μm of etched PET | |
| | 56 g/m² of blend 3 | |
| Example 14 | 94 g/m² of blend 7 | 300 μm |
| | 23 μm of etched PET | |
| | 94 g/m2 of blend 7 | |
| Example 15 | 43 g/m² of blend 7 | 150 μm |
| | 23 μm of etched PET | |
| | 43 g/m² of blend 7 | |
| Example 16 | 56 g/m² of blend 5 | 150 μm |
| | 23 μm of etched PET | |
| | 56 g/m² of blend 5 | |
| Example 17 | 51 g/m² of blend 2 | 150 μm |
| | 23 μm of etched PET | |
| | 51 g/m² of blend 2 | |
| Example 18 | 100 g/m² of blend 2 | 300 μm |
| | 50 μm of etched PET | |
| | 100 g/m² of blend 2 | |
| Example 19 | 51 g/m² of blend 4 | 150 μm |
| | 23 μm of etched PET | |
| | 51 g/m² of blend 4 | |
| Example 20 | 100 g/m² of blend 4 | 300 μm |
| | 50 μm of etched PET | |
| | 100 g/m² of blend 4 | |
| Example 21 | 40 g/m² of blend 3 | 100 μm |
| | 6 μm of etched PET | |
| | 40 g/m² of blend 3 | |
| Example 22 | 36 g/m² of blend 9 | 100 μm |
| | 6 μm of etched PET | |
| | 36 g/m² of blend 9 | |
| Example 23 | 30 g/m² of blend 1 | 100 μm |
| | 6 μm of etched PET | |
| | 30 g/m² of blend 1 | |
| Example 24 | 27 g/m² of blend 10 | 100 μm |
| | 6 μm of etched PET | |
| | 27 g/m² of blend 10 | |
| Example 25 | 40 g/m² of blend 11 | 100 μm |
| | 6 μm of etched PET | |
| | 40 g/m² of blend 11 | |
| Example 26 | 36 g/m² of blend 12 | 100 μm |
| | 6 μm of etched PET | |
| | 36 g/m² of blend 12 | |
| Example 27 | 30 g/m2 of blend 13 | 100 μm |
| | 6 μm of etched PET | |
| | 30 g/m² of blend 13 | |
| Example 28 | 27 g/m² of blend 14 | 100 μm |
| | 6 μm of etched PET | |
| | 27 g/m² of blend 14 | |
| Comparative | 30 g/m² of PSA composition 2^{#} | 150 μm |
| example 1 | 23 μm of etched PET | |
| | 50 g/m² of blend 1 | |
| | 30 g/m² of PSA composition 2^{#} | |
| Comparative | 75 g/m² of PSA composition 2^{#} | 300 μm |
| example 2 | 23 μm of etched PET | |
| | 86 g/m² of blend 1 | |
| | 75 g/m² of PSA composition 2^{#} | |
| Comparative | 47 g/m² of PSA composition 4^{#} | 100 μm |
| example 3 | 6 μm of etched PET | |
| | 47 g/m² of PSA composition 4^{#} | |
| Comparative | 47 g/m² of PSA composition 1^{#} | 100 pm |
| example 4 | 6 μm of etched PET | |
| | 47 g/m² of PSA composition 1^{#} | |
| Comparative | 44 g/m² of PSA composition 1^{#} | 110 μm |
| example 5 | 23 μm of etched PET | |
| | 44 g/m² of PSA composition 1^{#} | |

^{#}pressure-sensitive adhesive compositions without blending with microballoons

All the (etched/corona-treated) PET films used had tensile strengths in longitudinal direction of more than 180 N/mm² and in transverse direction of more than 200 N/mm². All PET films used additionally had elongation at break values in longitudinal direction of less than 200%, and in transverse direction of less than 120%. Tensile strengths and elongations at break were each ascertained by method R1.

### REFERENCE METHODS

Unless stated otherwise, all measurements were conducted at 23° C. and 50% rel. air humidity.

### Elongation at Break and Tensile Strength (Method R1)

Elongation at break and tensile strength were measured in accordance with DIN 53504 using dumbbell specimens of size S3 at a separation speed of 300 mm per min. The test conditions were 23° C. and 50% rel. air humidity.

### Tackifying Resin Softening Temperature (Method R2)

The tackifying resin softening temperature is carried out in accordance with the relevant methodology, which is known as Ring & Ball and is standardized according to ASTM E28.

### Gel Permeation Chromatography GPC (Method R3)

The figures for number-average molar mass Mn, weight-average molecular weight M_{w} and polydispersity PD are based on determination by gel permeation chromatography. The determination is carried out using a clear-filtered 100 μL sample (sample concentration 1 g/L). The eluent used is THF with 0.1% by volume of trifluoroacetic acid. The measurement is made at 25° C. The precolumn used is a column of the PSS-SDV type, 5μ, 10³ Å, ID 8.0 mm×50 mm. For the separation, the columns of the PSS-SDV type, 5μ, 10³ Å, and also 105 Å and 106 Å, each with ID 8.0 mm×300 mm (columns from Polymer Standards Service; detection by means of Shodex RI71 differential refractometer), are used. The flow rate is 1.0 mL per minute.

Calibration is effected against PMMA standards (polymethylmethacrylate calibration) or, in the case of (synthetic) rubbers, against polystyrene.

### Density (Method R4)

The density of the unfoamed and foamed adhesive composition layers is ascertained by forming the quotient of mass applied and thickness of the adhesive composition layer applied to a carrier or liner. The mass applied can by determining the mass of a section, defined in terms of its length and width, of such an adhesive composition layer applied to a carrier or liner, minus the (known or separately determinable) mass of a section of the same dimensions of the carrier material used.

The thickness of the layer can be determined by means of commercial thickness measuring instruments (caliper test instruments) with accuracies of less than a 1 μm deviation. If variations in thickness are found, the average of measurements at at least three representative sites is reported, i.e. more particularly not measured at creases, folds, specks and the like.

### Static Glass Transition Temperature T_{g} (Method R5)

Glass transition points—referred to synonymously as glass transition temperatures—are reported as the result of measurements by means of differential scanning calorimetry (DSC) according to DIN 53 765; especially sections 7.1 and 8.1, but with uniform heating and cooling rates of 10 K/min in all heating and cooling steps (cf. DIN 53 765; section 7.1; note 1). The sample weight is 20 mg.

### Micro-Shear Test

This test serves for rapid testing of the shear strength of adhesive tapes under thermal stress.

### Test Sample Preparation for Micro-Shear Test:

A piece of adhesive tape cut out of the respective specimen (length about 50 mm, width 10 mm) is bonded to an acetone-cleaned steel test sheet, such that the steel plate projects beyond the adhesive tape to the right and left and that the adhesive tape projects beyond the test plate at the upper edge by 2 mm. The bonding area of the sample is height·width=13 mm—10 mm. A 2 kg steel roll is then rolled over the bonding site six times at a speed of 10 m/min. The adhesive tape is reinforced flush with a stable adhesive strip which serves as contact point for the distance sensor. The sample is suspended vertically by means of the test plate.

### Micro-Shear Test:

The specimen to be analyzed is weighted down at the lower end with a weight of 300 g. The test temperature is 40° C., the test duration 30 minutes (15 minutes under stress and 15 minutes without stress). The shear travel after the given test duration at constant temperature is reported as the result in μm, specifically as the maximum value [“max”; maximum shear travel resulting from stress for 15 minutes]; as the minimum value [“min”; shear travel (“residual deflection”) after removal of stress 15 min; when stress is removed, there is reverse movement as a result of relaxation]. Likewise reported is the elastic component in % [“elast”; elastic component=(max−min)·100/max].

### Test Methods

Unless stated otherwise, all measurements were conducted at 23° C. and 50% rel. air humidity.

### Ball Drop Test (Impact Resistance) (Method P1)

A square sample in the shape of a frame was cut out of the adhesive tape to be examined (external dimensions 33 mm×33 mm; border width 3.0 mm; internal dimensions (window cut-out) 27 mm×27 mm). This sample was stuck to an ABS frame (external dimensions 45 mm×45 mm; border width 10 mm; internal dimensions (window cut-out) 25 mm×25 mm; thickness 3 mm). A PMMA window of 35 mm×35 mm was stuck to the other side of the double-sided adhesive tape. The bonding of ABS frame, adhesive tape frame and PMMA window was effected such that the geometric centers and the diagonals were each superimposed on one another (corner-to-corner). The bonding area was 360 mm². The bond was subjected to a pressure of 10 bar for 5 s and stored under conditions of 23° C./50% relative humidity for 24 hours.

Immediately after the storage, the adhesive composite composed of ABS frame, adhesive tape and PMMA sheet was placed by the protruding edges of the ABS frame onto a framework (sample holder) such that the composite was aligned horizontally and the PMMA sheet faced downward in a freely suspended manner. A steel ball (weight 5.6 g or 32.6 g) was allowed to drop vertically from a height of up to 250 cm (through the window of the ABS frame) centered onto the PMMA sheet in the sample thus arranged (test conditions 23° C., 50% relative humidity). Three tests were conducted with each sample, if the PMMA sheet had not become detached beforehand.

The ball drop test is considered to have been passed if the bond did not part in any of the three tests.

In order to be able to compare experiments with different ball weights, the energy was calculated as follows:

E=height [m]*ball weight [kg]*9.81 m/s²

### Push-Out Resistance (z Plane) (Method P2)

By means of the push-out test, it is possible to obtain conclusions as to how high the stability of a bond of a component is in a frame-like body, for example a window in a housing.

A rectangular sample in the shape of a frame was cut out of the adhesive tape to be examined (external dimensions 43 mm×33 mm; border width in each case 2.0 mm; internal dimensions (window cut-out) 39 mm×29 mm, bond area on the top and bottom side 288 mm² in each case). This sample was bonded to a rectangular ABS polymer frame (ABS=acrylonitrile-butadiene-styrene copolymers) (external dimensions 50 mm×40 mm, border width of each of the long borders 8 mm; border width of each of the short borders 10 mm; internal dimensions (window cut-out) 30 mm×24 mm; thickness 3 mm). A rectangular PMMA sheet (PMMA=polymethylmethacrylate) with dimensions of 45 mm×35 mm was bonded to the other side of the sample of the double-sided adhesive tape. The full available bonding area of the adhesive tape was utilized. The bonding of ABS frame, adhesive tape sample and PMMA window was effected such that the geometric centers, the angle bisectors of the acute diagonal angles and the angle bisectors of the obtuse diagonal angles of the rectangles were each superimposed on one another (corner-to-corner, long sides on long sides, short sides on short sides). The bonding area was 288 mm². The bond was subjected to a pressure of 10 bar for 5 s and stored under conditions of 23° C./50% relative humidity for 24 hours.

Immediately after the storage, the adhesive composite composed of ABS frame, adhesive tape and PMMA sheet was placed by the protruding edges of the ABS frame onto a framework (sample holder) such that the composite was aligned horizontally and the PMMA sheet faced downward in a freely suspended manner.

A pressure ram is then moved vertically upward through the window of the ABS frame at a constant speed of 10 mm/min, such that it presses onto the center of the PMMA sheet, and the respective force (determined from the respective pressure and contact area between the ram and sheet) is registered as a function of the time from the first contact of the ram with the PMMA sheet until just before it drops away (test conditions: 23° C., 50% relative humidity). The force acting immediately prior to the failure of the adhesive bond between PMMA sheet and ABS frame (maximum force Fₘₐₓ in the force-time diagram in N) is registered as the response of the push-out test.

### Bonding Force (Methods P3: Steel and P4: Polycarbonate)

The determination of bonding force (according to AFERA 5001) is conducted as follows. The defined bonding substrate used is a polished steel sheet (302 stainless steel according to ASTM A 666; 50 mm×125 mm×1.1 mm; shiny annealed surface; surface roughness 50±25 nm arithmetic average deviation from the baseline) or a polycarbonate. The bondable area element to be examined is cut to a width of 20 mm and a length of about 25 cm, provided with a handling section and, immediately thereafter, pressed onto the bonding substrate chosen in each case five times with a 4 kg steel roll at an advance rate of 10 m/min. Immediately thereafter, the bondable area element was pulled away from the bonding substrate at an angle of 180° with a tensile tester (from Zwick) at a speed v=300 mm/min, and the force required for the purpose at room temperature was measured. The measured value (in N/cm) is obtained as the average value from three individual measurements.

### Impact Resistance; z Direction (Method P5)

A square sample in the shape of a frame was cut out of the adhesive tape to be examined (external dimensions 33 mm×33 mm; border width 2.0 mm; internal dimensions (window cut-out) 29 mm×29 mm). This sample was stuck to a PC frame (external dimensions 45 mm×45 mm; border width 10 mm; internal dimensions (window cut-out) 25 mm×25 mm; thickness 3 mm). A PC window of 35 mm×35 mm was stuck to the other side of the double-sided adhesive tape. The bonding of PC frame, adhesive tape frame and PC window was effected such that the geometric centers and the diagonals were each superimposed on one another (corner-to-corner). The bonding area was 248 mm². The bond was subjected to a pressure of 248 N for 5 s and stored under conditions of 23° C./50% relative humidity for 24 hours.

Immediately after the storage, the adhesive composite composed of PC frame, adhesive tape and PC window was braced by the protruding edges of the PC frame in a sample holder such that the composite was aligned horizontally and the PC window was beneath the frame. The sample holder was then inserted centrally the intended receptacle of the “DuPont Impact Tester”. The impact head of weight 190 g was used in such a way that the circular impact geometry with a diameter of 20 mm impacted centrally and flush on the window side of the PC window.

A weight having a mass of 150 g guided on two guide rods was allowed to drop vertically from a height of 5 cm onto the composite composed of sample holder, sample and impact head thus arranged (test conditions: 23° C., 50% relative humidity). The height from which the weight dropped was increased in 5 cm steps until the impact energy introduced destroyed the sample as a result of the impact stress and the PC window parted from the PC frame.

In order to be able to compare experiments with different samples, the energy was calculated as follows:

E[J]=height [m]*mass of weight [kg]*9.81 m/s²

Five samples per product were tested, and the mean energy was reported as index for impact resistance.

### Antirepulsion Test (Method P6)

The bare side of the double-sided adhesive tape to be examined was bonded to a 0.5 mm-thick aluminum plate (external dimensions 150 mm×20 mm) with the aid of a rubber roller. The covered side was applied to the middle of a 3 mm-thick (external dimensions 200 mm×25 mm) PC sheet. The bonding area was 3000 mm². Thereafter, the adhesive bond composed of PC sheet, adhesive tape and aluminum plate was pressed by rolling a 4 kg hand roller back and forth five times and conditioned at 23° C./50% relative humidity for 72 hours.

Immediately after the storage, the adhesive bond was clamped by the protruding edges of the PC sheet into a circular arc-shaped sample holder with an opening angle of 33⁰ in such a way that the composite was aligned centrally and with the aluminum plate upward in the sample holder. The PC sheet was in full contact with the sample holder, such that the bond was also subjected to bending by the opening angle.

The composite composed of sample holder and adhesive bond in this arrangement was stored in a heating oven at a temperature of 50° C. for 48 hours.

Directly after the storage, a steel ruler was used to measure the lifting of the bond between adhesive tape and PC sheet or adhesive tape and aluminum plate in the perpendicular direction at the ends of the longitudinal sides of the adhesive bond.

In order to be able to compare experiments with different samples, the lifting was calculated for one sample by forming the average from the lifting of both sides.

Sample lifting [mm]=(lifting on the left [mm]+lifting on the right [mm])/2

Three samples per product were tested, and the average sample lifting was reported as an index for the repulsion resistance of the product. The smaller the lifting, the better the reliability of bonding with the adhesive product tested.

### Results

The results from the tests for the individual examples are presented in table 4 below:

TABLE 4

| | | | | | Impact | Steel | Polycarbonate | Repulsion |
|---|---|---|---|---|---|---|---|---|
| | Total | Density | Push- | Ball | resistance | bonding force | bonding force | resistance |
| | thickness | kg/m³ | out (N) | drop (J) | (z direction) (J) | [N/cm] | (N/cm) | (mm) |
| Test method | (cf. table 3) | R4 | P2 | P1 | P5 | P3 | P4 | P6 |
| Example 1 | 150 μm | 652 | 108 | 0.53 | 0.57 | | | |
| Example 2 | 300 μm | 650 | 138 | 0.80 | 0.93 | 14.7 | | |
| Example 3 | 150 μm | 857 | 142 | 0.46 | 1.09 | 12.4 | | |
| Example 4 | 150 μm | 695 | 91 | 0.53 | 0.72 | | | |
| Example 5 | 300 μm | 705 | 66 | 0.46 | 0.54 | | | |
| Example 6 | 150 μm | 855 | 96 | 0.46 | 0.87 | | | |
| Example 7 | 110 μm | 880 | 113 | 0.04 | 0.68 | | | |
| Example 8 | 110 μm | 775 | 88 | 0.08 | 0.49 | | | |
| Example 9 | 110 μm | 695 | 77 | 0.14 | 0.46 | | | |
| Example 10 | 110 μm | 570 | 60 | 0.21 | 0.35 | | | |
| Example 11 | 300 μm | 665 | 138 | 0.72 | 0.76 | 10.1 | | |
| Example 12 | 150 μm | 675 | 128 | 0.53 | 0.63 | 11.3 | | |
| Example 13 | 150 μm | 840 | 143 | 0.46 | 0.96 | 10.1 | | |
| Example 14 | 300 μm | 670 | 104 | 0.66 | 0.68 | | | |
| Example 15 | 150 μm | 700 | 70 | 0.46 | 0.51 | | | |
| Example 16 | 150 μm | 845 | 101 | 0.66 | 0.85 | | | |
| Example 17 | 150 μm | 790 | 129 | 0.59 | 0.79 | 9.8 | 10.1 | 36 |
| Example 18 | 300 μm | 793 | 126 | 0.80 | 0.97 | 14.5 | 15.7 | 15 |
| Example 19 | 150 μm | 805 | 138 | 0.59 | 0.74 | 10.6 | 10.2 | 10 |
| Example 20 | 300 μm | 790 | 129 | 0.78 | 0.94 | 12.5 | 13.6 | 4 |
| Example 21 | 100 μm | | | | 0.47 | | | |
| Example 22 | 100 μm | | | | 0.49 | | | |
| Example 23 | 100 μm | | | | 0.43 | | | |
| Example 24 | 100 μm | | | | 0.34 | | | |
| Example 25 | 100 μm | | | | 0.28 | | | |
| Example 26 | 100 μm | | | | 0.32 | | | |
| Example 27 | 100 μm | | | | 0.14 | | | |
| Example 28 | 100 μm | | | | 0.18 | | | |
| Comparative | 150 μm | 650 | 180 | 0.40 | 0.37 | 11.4 | 10.4 | |
| example 1 | | | | | | | | |
| Comparative | 300 μm | 665 | 164 | 0.46 | 0.51 | 11.2 | 11.2 | |
| example 2 | | | | | | | | |
| Comparative | 100 μm | | | | 0.10 | | | |
| example 3 | | | | | | | | |
| Comparative | 100 μm | 990 | 190 | 0.03 | 0.22 | 17 | | |
| example 4 | | | | | | | | |
| Comparative | 110 μm | 999 | 186 | 0.03 | 0.24 | | | |
| example 5 | | | | | | | | |

A target application for characterization of the demands presented in accordance with the invention is represented by the impact resistance test (method P5). Here, for the inventive examples, good results were found throughout, which are superior to those for the non-foamed comparative examples (comparative examples 3 and 4)—with corresponding product thicknesses in each case.

In addition, it is found that the impact resistance results for the three-layer products are superior with respect to four-layer products of comparable thickness (comparative examples 1 and 2).

The anti-repulsion test (method P6) shows another advantage of the bonded products that have been produced with the specific embodiment of the adhesive composition of the invention (adhesive composition 2 with coordinative and covalent—i.e. dual—crosslinking) over those with polyacrylate adhesive composition layers without dual crosslinking, and so the dual-crosslinked adhesive products are especially advantageous where the repulsion properties of the adhesive product are important. In this regard, see examples 17, 18 by comparison with examples 19, 20; examples 17 and 19 are of equal thickness to 18 and 20 respectively.

However, products that do not have dual crosslinking likewise have excellent values with regard to the other parameters.

It is also possible to infer the trend from the results that the optimal proportion of microballoons in the pressure-sensitive adhesive composition is within the range between 0.5 and 3 (in this regard see, for example, examples 7 to 10 and comparative example 5 with the same thickness and based on the same base adhesive composition).

It can be inferred from a comparison of examples 21 to 24 (pressure-sensitive adhesive composition 1 based on a blend of acrylate polymers and rubber) with examples 25 to 28 (resin-blended pressure-sensitive adhesive composition 4; resin-blended acrylate adhesive composition) that the blend composition has higher impact resistance values and hence is superior to the straight acrylate composition.

The respective measurement series (variation in the proportions of the microballoons in the respective examples 21 to 24 and comparative example 4, or examples 25 to 28 and comparative example 3) confirm the optimal content of microballoons already ascertained above in the respective pressure-sensitive adhesive compositions.

1. A pressure-sensitive adhesive strip composed of three layers, comprising
(i) an inner layer F composed of a film carrier,
(ii) a layer SK1 composed of a self-adhesive composition arranged on one of the surfaces of the film carrier layer F and based on a foamed acrylate composition,
(iii) a layer SK2 composed of a self-adhesive composition arranged on the opposite surface of the film carrier layer F from layer SK1 and based on a foamed acrylate composition.

2. The pressure-sensitive adhesive strip as claimed in claim 1, wherein
the film carrier is nonextensible.

3. The pressure-sensitive adhesive strip as claim 1, wherein
the film carrier has a tensile strength of in each case more than 100 N/mm², in longitudinal direction and in transverse direction.

4. The pressure-sensitive adhesive strip as claimed in claim 1, having:
a symmetric construction in relation to the composition of the layers, in that the foamed self-adhesive acrylate compositions of the two self-adhesive composition layers SK and SK2 are chemically identical, and/or
a structurally symmetric construction, that the two self-adhesive composition layers SK1 and SK2 are of the same thickness and/or have the same density.

5. (canceled)

6. The pressure-sensitive adhesive strip as claimed in claim 1, wherein
one or both surfaces of the film carrier layer F have been physically and/or chemically pretreated, wherein optionally the pretreatment is an etching operation and/or a corona treatment and/or a primer treatment.

7. (canceled)

8. The pressure-sensitive adhesive strip as claimed in claim 1, wherein
the acrylate composition for at least one of the self-adhesive composition layers SK1 and SK2 is formed using a polyacrylate that can be derived from the following monomer composition:
(i) acrylic esters and/or methacrylic esters of the following formula: CH₂=C(R¹)(COOR²)
where R¹═H or CH₃ and R²═H or linear, branched or cyclic, saturated or unsaturated alkyl radicals having 1 to 30 and especially having 4 to 18 carbon atoms,
(ii) optionally olefinically unsaturated comonomers having functional groups of the type already defined for reactivity with epoxy groups,
(iii) optionally further acrylates and/or methacrylates and/or olefinically unsaturated monomers copolymerizable with component (i).

9. The pressure-sensitive adhesive strip as claimed in claim 1, wherein
the pressure-sensitive adhesive compositions for at least one of the self-adhesive composition layers SK1 and SK2 comprise at least the following two components:
(P) a first, polyacrylate-based polymer component,
(E) a second, elastomer-based polymer component which is essentially immiscible with the polyacrylate component.

10. The pressure-sensitive adhesive strip as claimed in claim 9, wherein
the polyacrylate-based polymer component (P) has a proportion of 60% by weight to 90% by weight,
the elastomer-based polymer component (E) has a proportion of 10% by weight to 40% by weight,
in the entirety (100%) of the two components (P) and (E).

11. The pressure-sensitive adhesive strip as claimed in claim 9, wherein the
elastomer-based polymer component (C) is formed by one or more synthetic rubbers or comprises one or more synthetic rubbers.

12. The pressure-sensitive adhesive strip as claimed in claim 1, wherein
the pressure-sensitive adhesive compositions for at least one of the self-adhesive composition layers SK1 and SK2 have been admixed with crosslinkers.

13. The pressure-sensitive adhesive strip as claimed in claim 1, wherein
the adhesive composition for at least one and of the self-adhesive composition layers SK1 and SK2 is a crosslinkable adhesive composition consisting of
(a) at least one first base component comprising
(a1) as the first polymer component a base polymer component (also referred to hereinafter as base polymer for short) composed of a homopolymer, a copolymer or a homogeneous mixture of two or more homopolymers, two or more copolymers or one or more homopolymers with one or more copolymers,
where at least one of the homopolymers or at least one of the copolymers, or all the polymers, in the base polymer component have groups that are functional in respect of the crosslinking,
(a2) optionally further constituents that are homogeneously miscible with or soluble in the base polymer component;
(b) optionally a second component comprising
(b1) as a further polymer component polymers that are essentially not homogeneously miscible with the base polymer,
(b2) optionally further constituents that are essentially not homogeneously miscible with and insoluble in the base polymer, where component (f) is wholly or partly homogeneously miscible with the further polymer component (b) optionally present;
(c) crosslinkers selected from (c1) and (c2) below:
(c1) at least one covalent crosslinker,
(c2) at least one coordinative crosslinker,
and
(d) optionally solvents or solvent residues.

14. The pressure-sensitive adhesive strip as claimed claim 1, wherein
15 to 100 parts by weight of tackifier per 100 parts by weight of adhesive composition without tackifier have been added to the pressure-sensitive adhesive compositions for at least one of the self-adhesive composition layers SK1 and SK2.

15. The pressure-sensitive adhesive strip as claimed in claim 1, wherein
the tackifiers are tackifying resins.

16. The pressure-sensitive adhesive strip as claimed in claim 1, wherein
the polymer matrix of the self-adhesive composition layers SK1 and/or SK2 is foamed using microballoons.

17. The pressure-sensitive adhesive strip as claimed in claim 1, wherein
the proportion of the microballoons in the self-adhesive composition layer SK1 or the self-adhesive composition layer SK2 or in both self-adhesive composition layers SK1 and SK2 (based on the unexpanded microballoons) is up to 12% by weight, based in each case on the overall composition of the corresponding layer SK1 or SK2.

18. The pressure-sensitive adhesive strip as claimed in claim 1, wherein
after foaming, at least 90% of all voids formed by microballoons in layer SK1 or layer SK2 or in both layers SK and SK2 have a maximum diameter of 7 to 200 μm.

19. The pressure-sensitive adhesive strip as claimed in claim 18, wherein
the elastomer component in the polyacrylate component forms domains, where the maximum diameter of at least 90% of the domains of the elastomer component is within the size range below 100 μm, and the maximum diameter of the voids formed by at least 90% of all microballoons is likewise below 100 μm.

20. The pressure-sensitive adhesive strip as claimed in claim 16, wherein
microballoons that have been pre-expanded only slightly, if at all, are incorporated into the polymer matrix of the self-adhesive composition layers SK1 and/or SK2 and are expanded only after having been incorporated.

21. The pressure-sensitive adhesive strip as claimed in claim 16, wherein
the microballoons for the foaming of the self-adhesive composition layers SK1 and/or SK2 are chosen such that the ratio of the density of the polymer matrix of the corresponding adhesive composition layers to the density of the (non-pre-expanded or only slightly pre-expanded) microballoons to be incorporated into the polymer matrix of the respective layer itself is between 1 and 1:6.

22. A method for bonding of components selected from the group consisting of accumulators and electronic devices, comprising a step of applying the pressure-sensitive adhesive strip of claim 1 to a substrate.
